(19) United States
(12) Patent Application Publication
(10) Pub. No.: US 2014/0098754 A1
(43) Pub. Date: Apr. 10, 2014

(54) METHODS AND APPARATUS FOR IMPROVED RESOURCE MANAGEMENT IN LTE

(71) Applicant: QUALCOMM Incorporated, San Diego, CA (US)

(72) Inventors: Tao Luo, San Diego, CA (US); Wanshi Chen, San Diego, CA (US); Peter Gaal, San Diego, CA (US); Hao Xu, San Diego, CA (US); Valentin Alexandru Gheorghiu, Tokyo (JP); Tingfang Ji, San Diego, CA (US); Masato Kitazoe, Tokyo (JP)

(73) Assignee: QUALCOMM Incorporated, San Diego, CA (US)

(21) Appl. No.: 13/898,704

(22) Filed: May 21, 2013

Related U.S. Application Data
(60) Provisional application No. 61/712,231, filed on Oct. 10, 2012.
(60) Provisional application No. 61/711,711, filed on Oct. 9, 2012.

(51) Int. Cl. H04W 72/04

(52) U.S. Cl. CPC H04W 72/04
USPC 370/329

(57) ABSTRACT

Certain aspects of the present disclosure relate to methods and apparatus for improved resource management in LTE. Methods and apparatus are provided for receiving, by a user equipment (UE), signaling providing an indication of a set of one or more subframes in which a set of resources are non-usable for one or more functions performed by the UE, or determining of the set by the UE, and excluding the non-usable resources when performing the one or more functions. Methods and apparatus are provided for identifying, by a base station (BS), a set of one or more subframes in which a set of resources might not be suitable for one or more functions performed by a user equipment (UE) and transmitting signaling, to the UE, providing an indication the set of resources are non-usable in the one or more subframes for the one or more functions performed by the UE.

### CLAIM OF PRIORITY UNDER 35 U.S.C. §119

This application claims benefit of U.S. Provisional Patent Application Ser. No. 61/712,231, filed Oct. 10, 2012, which is herein incorporated by reference in its entirety, and U.S. Provisional Patent Application Ser. No. 61/711,711, filed Oct. 9, 2012, which is herein incorporated by reference in its entirety.

### BACKGROUND

I. Field

Certain aspects of the disclosure generally relate to wireless communications and, more particularly, to methods and apparatus for improved resource management in LTE.

II. Background

Wireless communication networks are widely deployed to provide various communication services such as voice, video, packet data, messaging, broadcast, etc. These wireless networks may be multiple-access networks capable of supporting multiple users by sharing the available network resources. Examples of such multiple-access networks include Code Division Multiple Access (CDMA) networks, Time Division Multiple Access (TDMA) networks, Frequency Division Multiple Access (FDMA) networks, Orthogonal FDMA (OFDMA) networks and Single-Carrier FDMA (SC-FDMA) networks.

A wireless communication network may include a number of base stations (BS) that can support communication for a number of user equipments (UEs). A UE may communicate with a base station via the downlink and uplink. The downlink (or forward link) refers to the communication link from the base station to the UE, and the uplink (or reverse link) refers to the communication link from the UE to the base station.

A base station may transmit data and control information on the downlink to a UE and/or may receive data and control information on the uplink from the UE. On the downlink, a transmission from the base station may observe interference due to transmissions from neighbor base stations. On the uplink, a transmission from the UE may cause interference to transmissions from other UEs communicating with the neighbor base stations. The interference may degrade performance on both the downlink and uplink.

### SUMMARY

Certain aspects of the present disclosure provide methods and apparatus for improved resource (e.g., resources for reference signals) management in LTE.

Certain aspects provide a method for wireless communications by a user equipment (UE). The method generally includes receiving signaling providing an indication of a set of one or more subframes in which a set of resources are non-usable for one or more functions performed by the UE and excluding the non-usable resources when performing the one or more functions

Certain aspects provide a method for wireless communications by a base station (BS). The method generally includes identifying a set of one or more subframes in which a set of resources might not be suitable for one or more functions performed by a user equipment (UE) and transmitting signaling, to the UE, providing an indication the set of resources are non-usable in the one or more subframes for the one or more functions performed by the UE.

Certain aspects provide a method for wireless communications by a user equipment (UE). The method generally includes determining at least one type of physical downlink control channel (PDCCH) to use for radio link monitoring (RLM) procedures and performing RLM procedures based on the determination.

Certain aspects provide a method for wireless communications by a user equipment (UE). The method generally includes determining a first starting symbol position for one or more downlink channels based on channel monitoring, determining a second starting position for the one or more downlink channels based on received signaling, and employing the first or second starting symbol position based on an event.

Certain aspects provide an apparatus for wireless communications by a user equipment (UE). The apparatus generally includes means for receiving signaling providing an indication of a set of one or more subframes in which a set of resources are non-usable for one or more functions performed by the UE and means for excluding the non-usable resources when performing the one or more functions.

Certain aspects provide an apparatus for wireless communications by a user equipment (UE). The apparatus generally includes at least one processor configured to receive signaling providing an indication of a set of one or more subframes in which a set of resources are non-usable for one or more functions performed by the UE and exclude the non-usable resources when performing the one or more functions. The apparatus also includes a memory coupled with the at least one processor.

Certain aspects provide a computer program product. The computer program product generally includes a computer-readable medium comprising code for receiving signaling providing an indication of a set of one or more subframes in which a set of resources are non-usable for one or more functions performed by the UE and excluding the non-usable resources when performing the one or more functions.

Certain aspects provide an apparatus for wireless communications by a base station (BS). The apparatus generally includes means for identifying a set of one or more subframes in which a set of resources might not be suitable for one or more functions performed by a user equipment (UE) and means for transmitting signaling, to the UE, providing an indication the set of resources are non-usable in the one or more subframes for the one or more functions performed by the UE.

Certain aspects provide an apparatus for wireless communications by a base station (BS). The apparatus generally includes at least one processor configured to identify a set of one or more subframes in which a set of resources might not be suitable for one or more functions performed by a user equipment (UE) and transmit signaling, to the UE, providing an indication the set of resources are non-usable in the one or more subframes for the one or more functions performed by the UE. The apparatus also includes a memory coupled with the at least one processor.

Certain aspects provide a computer program product. The computer program product generally includes a computer-readable medium comprising code for identifying a set of one or more subframes in which a set of resources might not be suitable for one or more functions performed by a user equipment (UE) and transmitting signaling, to the UE, providing an indication the set of resources are non-usable in the one or more subframes for the one or more functions performed by the UE.

Certain aspects provide an apparatus for wireless communications by a user equipment (UE). The apparatus generally includes means for determining at least one type of physical downlink control channel (PDCCH) to use for radio link monitoring (RLM) procedures and means for performing RLM procedures based on the determination.

Certain aspects provide an apparatus for wireless communications by a user equipment (UE). The apparatus generally includes at least one processor configured to determine at least one type of physical downlink control channel (PDCCH) to use for radio link monitoring (RLM) procedures and perform RLM procedures based on the determination. The apparatus also includes a memory coupled with the at least one processor.

Certain aspects provide a computer program product. The computer program product generally includes a computer-readable medium comprising code for determining at least one type of physical downlink control channel (PDCCH) to use for radio link monitoring (RLM) procedures and performing RLM procedures based on the determination.

Certain aspects provide an apparatus for wireless communications by a user equipment (UE). The apparatus generally includes means for determining a first starting symbol position for one or more downlink channels based on channel monitoring, means for determining a second starting position for the one or more downlink channels based on received signaling, and means for employing the first or second starting symbol position based on an event.

Certain aspects provide an apparatus for wireless communications by a user equipment (UE). The apparatus generally includes at least one processor configured to determine a first starting symbol position for one or more downlink channels based on channel monitoring, determine a second starting position for the one or more downlink channels based on received signaling, and employ the first or second starting symbol position based on an event. The apparatus also includes a memory coupled with the at least one processor.

Certain aspects provide a computer program product. The computer program product generally includes a computer-readable medium comprising code for determining a first starting symbol position for one or more downlink channels based on channel monitoring, determining a second starting position for the one or more downlink channels based on received signaling, and employing the first or second starting symbol position based on an event.

Numerous other aspects including apparatus, systems, computer program products, and processing systems are provided.

### BRIEF DESCRIPTION OF THE DRAWINGS

FIG. 1 is a block diagram conceptually illustrating an example of a wireless communications network, in accordance with certain aspects of the present disclosure.

FIG. 2 is a block diagram conceptually illustrating an example of a frame structure in a wireless communications network, in accordance with certain aspects of the present disclosure.

FIG. 2A illustrates an example subframe with various options for ePDCCH, in accordance with certain aspects of the present disclosure.

FIG. 2B shows an example format for the uplink in Long Term Evolution (LTE), in accordance with certain aspects of the present disclosure.

FIG. 3 shows a block diagram conceptually illustrating an example of a eNode B in communication with a user equipment device (UE) in a wireless communications network, in accordance with certain aspects of the present disclosure.

FIG. 4 illustrates an example heterogeneous network (HetNet), in accordance with certain aspects of the present disclosure.

FIG. 5 illustrates example resource partitioning in a heterogeneous network, in accordance with certain aspects of the present disclosure.

FIG. 6 illustrates example cooperative partitioning of subframes in a heterogeneous network, in accordance with certain aspects of the present disclosure.

FIG. 7 is a diagram illustrating a range expanded cellular region in a heterogeneous network, in accordance with certain aspects of the present disclosure.

FIG. 8 is a diagram illustrating a network with a macro eNB and remote radio heads (RRHs), in accordance with certain aspects of the present disclosure.

FIG. 9 illustrates example subframes in a heterogeneous network, in accordance with certain aspects of the present disclosure.

FIG. 10 illustrates an example of subframe-dependent non-usable resources, in accordance with certain aspects of the present disclosure.

FIG. 11 illustrates examples of function-dependent non-usable resources, in accordance with certain aspects of the present disclosure.

FIG. 12 illustrates example operations that may be performed by a user equipment (UE), in accordance with certain aspects of the present disclosure.

FIG. 13 illustrates example operations that may be performed by a base station (BS), in accordance with certain aspects of the present disclosure.

FIG. 14 illustrates example operations that may be performed by a user equipment (UE), according to certain aspects of the present disclosure.

FIG. 15 illustrates example operations 1500 that may be performed by a user equipment (UE), according to certain aspects of the present disclosure.

### DETAILED DESCRIPTION

Aspects of the present disclosure provide methods and apparatus for improved resource (e.g., resources for reference signals) management in LTE.

The techniques described herein may be used for various wireless communication networks such as CDMA, TDMA, FDMA, OFDMA, SC-FDMA and other networks. The terms “network” and “system” are often used interchangeably. A CDMA network may implement a radio technology such as Universal Terrestrial Radio Access (UTRA), cdma2000, etc. UTRA includes Wideband CDMA (WCDMA) and other variants of CDMA. CDMA2000 covers IS-2000, IS-95, and IS-856 standards. A TDMA network may implement a radio technology such as Global System for Mobile Communications (GSM). An OFDMA network may implement a radio technology such as Evolved UTRA (E-UTRA), Ultra Mobile Broadband (UMB), IEEE 802.11 (Wi-Fi), IEEE 802.16 (WiMAX), IEEE 802.20, Flash-OFDM®, etc. UTRA and E-UTRA are part of Universal Mobile Telecommunication System (UMTS). 3GPP Long Term Evolution (LTE) and LTE-Advanced (LTE-A) are new releases of UMTS that use E-UTRA. UTRA, E-UTRA, UMTS, LTE, LTE-A and GSM are described in documents from an organization named “3rd Generation Partnership Project” (3GPP). CDMA2000 and UMB are described in documents from an organization named “3rd Generation Partnership Project 2” (3GPP2). The techniques described herein may be used for the wireless networks and radio technologies mentioned above as well as other wireless networks and radio technologies. For clarity, certain aspects of the techniques are described below for LTE, and LTE terminology is used in much of the description below.

### Example Wireless Network

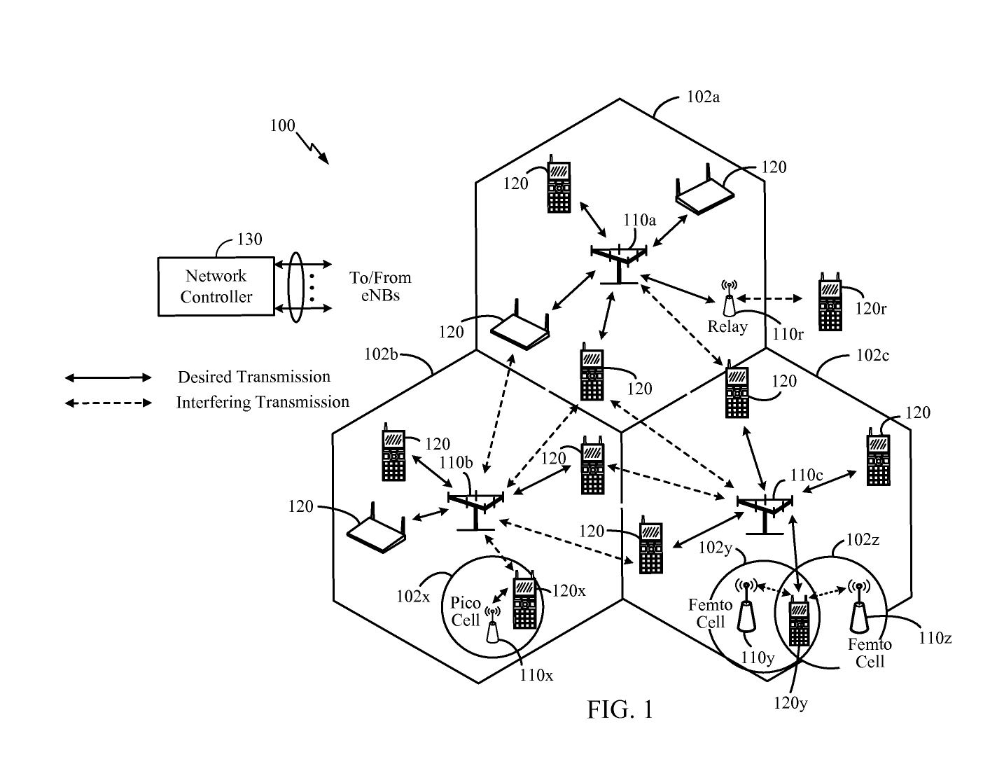

FIG. 1 shows a wireless communication network 100, which may be an LTE network. The wireless network 100 may include a number of evolved Node Bs (eNBs) 110 and other network entities. An eNB may be a station that communicates with user equipment devices (UEs) and may also be referred to as a base station, a Node B, an access point, etc. Each eNB 110 may provide communication coverage for a particular geographic area. In 3GPP, the term “cell” can refer to a coverage area of an eNB and/or an eNB subsystem serving this coverage area, depending on the context in which the term is used.

An eNB may provide communication coverage for a macro cell, a pico cell, a femto cell, and/or other types of cell. A macro cell may cover a relatively large geographic area (e.g., several kilometers in radius) and may allow unrestricted access by UEs with service subscription. A pico cell may cover a relatively small geographic area and may allow unrestricted access by UEs with service subscription. A femto cell may cover a relatively small geographic area (e.g., a home) and may allow restricted access by UEs having association with the femto cell (e.g., UEs in a Closed Subscriber Group (CSG), UEs for users in the home, etc.). An eNB for a macro cell may be referred to as a macro eNB (e.g., a macro base station). An eNB for a pico cell may be referred to as a pico eNB (e.g., a pico base station). An eNB for a femto cell may be referred to as a femto eNB (e.g., a femto base station) or a home eNB. In the example shown in FIG. 1, eNBs 110a, 110b, and 110c may be macro eNBs for macro cells 102a, 102b, and 102c, respectively. eNB 110x may be a pico eNB for a pico cell 102x. eNBs 110y and 110z may be femto eNBs for femto cells 102y and 102z, respectively. An eNB may support one or multiple (e.g., three) cells.

The wireless network 100 may also include relay stations. A relay station is a station that receives a transmission of data and/or other information from an upstream station (e.g., an eNB or a UE) and sends a transmission of the data and/or other information to a downstream station (e.g., a UE or an eNB). A relay station may also be a UE that relays transmissions for other UEs. In the example shown in FIG. 1, a relay station 110r may communicate with eNB 110a and a UE 120r in order to facilitate communication between eNB 110a and UE 120r. A relay station may also be referred to as a relay eNB, a relay, etc.

The wireless network 100 may be a heterogeneous network (HetNet) that includes eNBs of different types, e.g., macro eNBs, pico eNBs, femto eNBs, relays, etc. These different types of eNBs may have different transmit power levels, different coverage areas, and different impact on interference in the wireless network 100. For example, macro eNBs may have a high transmit power level (e.g., 20 watts) whereas pico eNBs, femto eNBs, and relays may have a lower transmit power level (e.g., 1 watt).

The wireless network 100 may support synchronous or asynchronous operation. For synchronous operation, the eNBs may have similar frame timing, and transmissions from different eNBs may be approximately aligned in time. For asynchronous operation, the eNBs may have different frame timing, and transmissions from different eNBs may not be aligned in time. The techniques described herein may be used for both synchronous and asynchronous operation.

A network controller 130 may couple to a set of eNBs and provide coordination and control for these eNBs. The network controller 130 may communicate with eNBs 110 via a backhaul. The eNBs 110 may also communicate with one another, e.g., directly or indirectly via wireless or wireline backhaul.

The UEs 120 may be dispersed throughout the wireless network 100, and each UE may be stationary or mobile. A UE may also be referred to as a terminal, a mobile station, a subscriber unit, a station, etc. A UE may be a cellular phone, a personal digital assistant (PDA), a wireless modem, a wireless communication device, a handheld device, a laptop computer, a cordless phone, a wireless local loop (WLL) station, a tablet, etc. A UE may be able to communicate with macro eNBs, pico eNBs, femto eNBs, relays, etc. In FIG. 1, a solid line with double arrows indicates desired transmissions between a UE and a serving eNB, which is an eNB designated to serve the UE on the downlink and/or uplink. A dashed line with double arrows indicates interfering transmissions between a UE and an eNB. For certain aspects, the UE may comprise an LTE Release 10 UE. However, in some aspects, the UE may comply with one or more other LTE Release versions.

LTE utilizes orthogonal frequency division multiplexing (OFDM) on the downlink and single-carrier frequency division multiplexing (SC-FDM) on the uplink. OFDM and SC-FDM partition the system bandwidth into multiple (K) orthogonal subcarriers, which are also commonly referred to as tones, bins, etc. Each subcarrier may be modulated with data. In general, modulation symbols are sent in the frequency domain with OFDM and in the time domain with SC-FDM. The spacing between adjacent subcarriers may be fixed, and the total number of subcarriers (K) may be dependent on the system bandwidth. For example, K may be equal to 128, 256, 512, 1024, or 2048 for system bandwidth of 1.25, 2.5, 5, 10, or 20 megahertz (MHz), respectively. The system bandwidth may also be partitioned into subbands. For example, a subband may cover 1.08 MHz, and there may be 1, 2, 4, 8, or 16 subbands for system bandwidth of 1.25, 2.5, 5, 10, or 20 MHz, respectively.

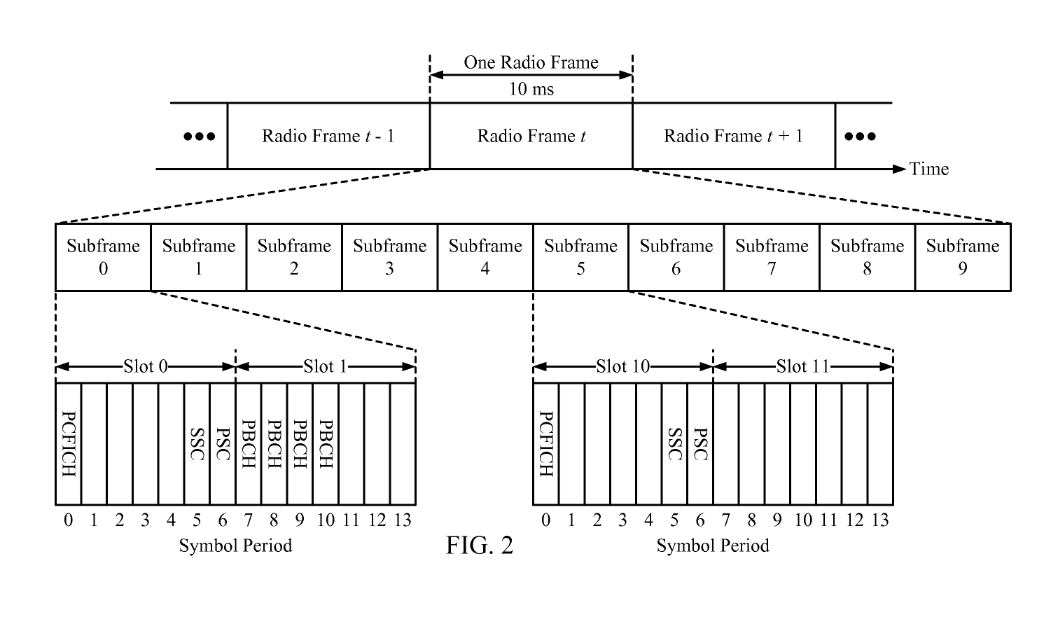

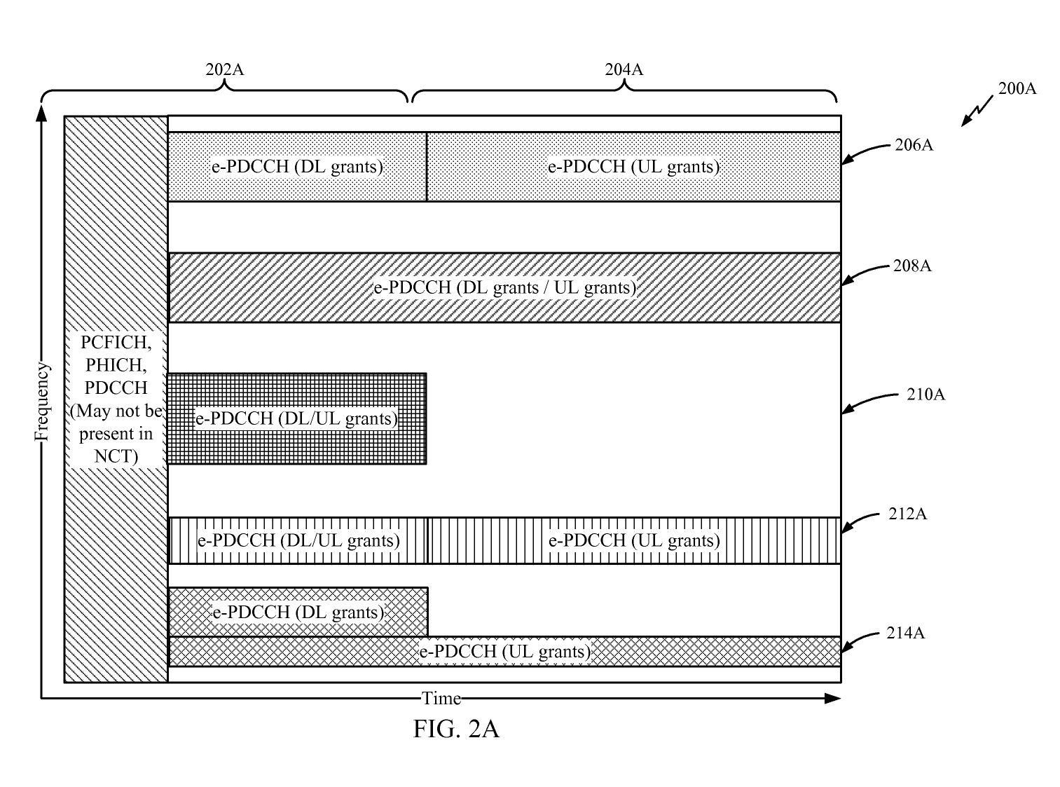

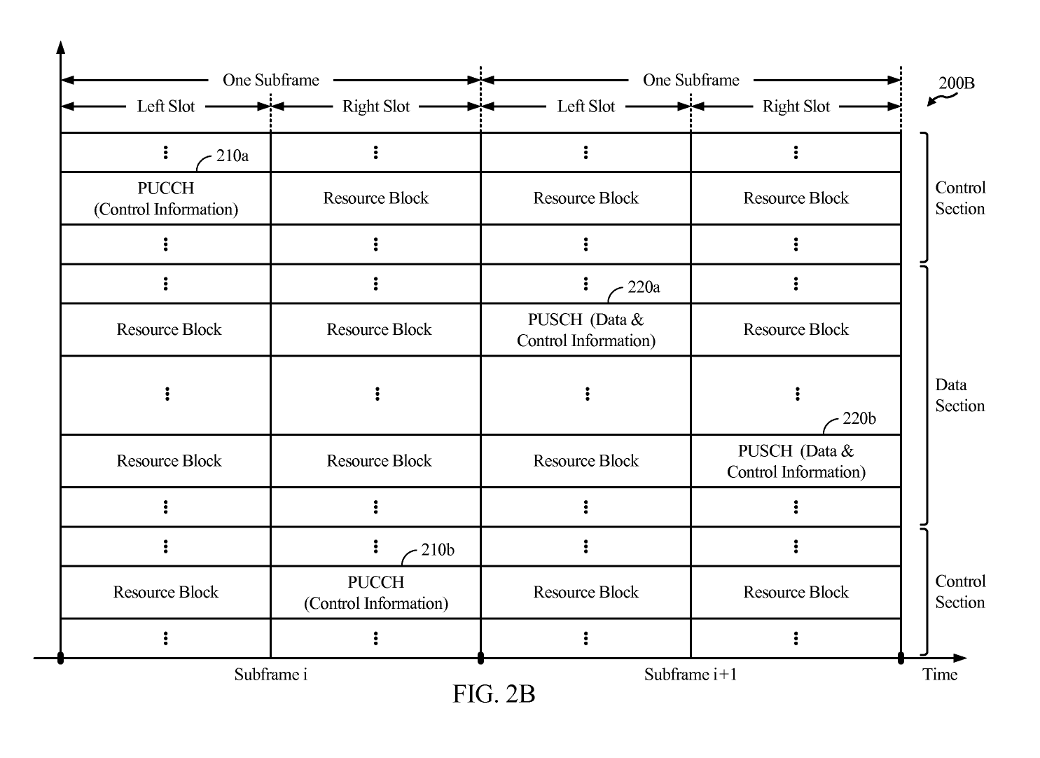

FIG. 2 shows a frame structure used in LTE. The transmission timeline for the downlink may be partitioned into units of radio frames. Each radio frame may have a predetermined duration (e.g., 10 milliseconds (ms)) and may be partitioned into 10 subframes with indices of 0 through 9. Each subframe may include two slots. Each radio frame may thus include 20 slots with indices of 0 through 19. Each slot may include L symbol periods, e.g., L=7 symbol periods for a normal cyclic prefix (as shown in FIG. 2) or L=6 symbol periods for an extended cyclic prefix. The 2L symbol periods in each subframe may be assigned indices of 0 through 2L−1. The available time frequency resources may be partitioned into resource blocks. Each resource block may cover N subcarriers (e.g., 12 subcarriers) in one slot.

In LTE, an eNB may send a primary synchronization signal (PSS) and a secondary synchronization signal (SSS) for each cell in the eNB. The primary and secondary synchronization signals may be sent in symbol periods 6 and 5, respectively, in each of subframes 0 and 5 of each radio frame with the normal cyclic prefix, as shown in FIG. 2. The synchronization signals may be used by UEs for cell detection and acquisition. The eNB may send a Physical Broadcast Channel (PBCH) in symbol periods 0 to 3 in slot 1 of subframe 0. The PBCH may carry certain system information.

The eNB may send a Physical Control Format Indicator Channel (PCFICH) in the first symbol period of each subframe, as shown in FIG. 2. The PCFICH may convey the number of symbol periods (M) used for control channels, where M may be equal to 1, 2, or 3 and may change from subframe to subframe. M may also be equal to 4 for a small system bandwidth, e.g., with less than 10 resource blocks. The eNB may send a Physical HARQ Indicator Channel (PHICH) and a Physical Downlink Control Channel (PDCCH) in the first M symbol periods of each subframe (not shown in FIG. 2). The PHICH may carry information to support hybrid automatic repeat request (HARQ). The PDCCH may carry information on resource allocation for UEs and control information for downlink channels. The eNB may send a Physical Downlink Shared Channel (PDSCH) in the remaining symbol periods of each subframe. The PDSCH may carry data for UEs scheduled for data transmission on the downlink. The various signals and channels in LTE are described in 3GPP TS 36.211, entitled “Evolved Universal Terrestrial Radio Access (E-UTRA); Physical Channels and Modulation,” which is publicly available.

The eNB may send the PSS, SSS, and PBCH in the center 1.08 MHz of the system bandwidth used by the eNB. The eNB may send the PCFICH and PHICH across the entire system bandwidth in each symbol period in which these channels are sent. The eNB may send the PDCCH to groups of UEs in certain portions of the system bandwidth. The eNB may send the PDSCH to specific UEs in specific portions of the system bandwidth. The eNB may send the PSS, SSS, PBCH, PCFICH, and PHICH in a broadcast manner to all UEs, may send the PDCCH in a unicast manner to specific UEs and may also send the PDSCH in a unicast manner to specific UEs.

A number of resource elements may be available in each symbol period. Each resource element may cover one subcarrier in one symbol period and may be used to send one modulation symbol, which may be a real or complex value. Resource elements not used for a reference signal in each symbol period may be arranged into resource element groups (REGs). Each REG may include four resource elements in one symbol period. The PCFICH may occupy four REGs, which may be spaced approximately equally across frequency, in symbol period 0. The PHICH may occupy three REGs, which may be spread across frequency, in one or more configurable symbol periods. For example, the three REGs for the PHICH may all belong in symbol period 0 or may be spread in symbol periods 0, 1, and 2. The PDCCH may occupy 9, 18, 36, or 72 REGs, which may be selected from the available REGs, in the first M symbol periods, for example. Only certain combinations of REGs may be allowed for the PDCCH.

A UE may know the specific REGs used for the PHICH and the PCFICH. The UE may search different combinations of REGs for the PDCCH. The number of combinations to search is typically less than the number of allowed combinations for the PDCCH. An eNB may send the PDCCH to the UE in any of the combinations that the UE will search.

In LTE Rel-11, for example, a new control channel (e.g., enhanced PDCCH (ePDCCH)) may be introduced. Unlike the legacy PDCCH, which occupies the first several control symbols in a subframe, ePDCCH may occupy the data region, similar to PDSCH. ePDCCH may help increase control channel capacity, support frequency-domain inter-cell interference coordination (ICIC), achieve improved spatial reuse of control channel resources, support beamforming and/or diversity, operate on a new carrier type (NCT) and in multimedia broadcast single frequency network (MBSFN) subframes, and coexist on the same carrier as legacy UEs.

FIG. 2A illustrates an example subframe 200A with various options for ePDCCH, in accordance with certain aspects of the present disclosure. The subframe 200A is divided into a first slot 202A and a second slot 204A, wherein each slot typically comprises 7 symbols in LTE for the normal cyclic prefix (CP) case. Each subframe in LTE spans 1 ms, and therefore, each slot has a duration of 0.5 ms. The first 3 symbols of the subframe 200A may be used for the Physical Control Format Indicator Channel (PCFICH), the Physical HARQ Indicator Channel (PHICH), and the PDCCH. Various ePDCCH structures are available for conveying information in the subframe 400, as illustrated. Both localized and distributed transmission of the enhanced control channel may be supported.

According to a first alternative 206A, the ePDCCH may be transmitted similarly to transmission of a relay PDCCH (R-PDCCH). In this case, DL grants may be transmitted in the first slot 202A, and UL grants may be transmitted in the second slot 204A. For certain aspects, the second slot 204A may be used for downlink data transmission if it is not being used for transmission of UL grants.

According to a second alternative 208A, the ePDCCH may be transmitted in a pure FDM scheme, where DL grants and UL grants span the resource block. As shown, a set of resources in the frequency domain are allocated for transmission of the ePDCCH across a time domain comprising the first and second time slots 202A, 204A. For certain aspects, a subset of RBs multiplexed in the frequency domain with the PDSCH are allocated for transmitting the ePDCCH including both uplink and downlink grants across the first and second time slots 202A, 204A.

According to a third alternative 210A, the ePDCCH may be transmitted in the first slot 202A according to a TDM scheme, where DL and UL grants are transmitted in the first slot. As illustrated for the third alternative 210A, the remaining RBs may be utilized for transmitting the PDSCH data transmissions.

According to a fourth alternative 212A, the ePDCCH may be transmitted in a manner similar to R-PDCCH, where DL and UL grants may be transmitted in the first slot 202A, and UL grants may be transmitted in the second slot 204A. For certain aspects, if a DL grant is transmitted in a first physical resource block (PRB) of a given PRB pair, then a UL grant may be transmitted in a second PRB of the PRB pair. Otherwise, a UL grant may be transmitted in either the first or second PRB of the PRB pair.

According to a fifth alternative 214A, the ePDCCH may be transmitted using TDM for DL grants in the first slot 202A and FDM for UL grants spanning the first and second slots 202A, 204A.

FIG. 2B shows an exemplary format 200B for the uplink in LTE. The available resource blocks for the uplink may be partitioned into a data section and a control section. The control section may be formed at the two edges of the system bandwidth and may have a configurable size. The resource blocks in the control section may be assigned to UEs for transmission of control information. The data section may include all resource blocks not included in the control section. The design in FIG. 2B results in the data section including contiguous subcarriers, which may allow a single UE to be assigned all of the contiguous subcarriers in the data section.

A UE may be assigned resource blocks in the control section to transmit control information to an eNB. The UE may also be assigned resource blocks in the data section to transmit data to the eNB. The UE may transmit control information in a Physical Uplink Control Channel (PUCCH) 210a, 210b on the assigned resource blocks in the control section. The UE may transmit only data or both data and control information in a Physical Uplink Shared Channel (PUSCH) 220a, 220b on the assigned resource blocks in the data section. An uplink transmission may span both slots of a subframe and may hop across frequency as shown in FIG. 2B.

A UE may be within the coverage of multiple eNBs. One of these eNBs may be selected to serve the UE. The serving eNB may be selected based on various criteria such as received power, pathloss, signal-to-noise ratio (SNR), etc.

A UE may operate in a dominant interference scenario in which the UE may observe high interference from one or more interfering eNBs. A dominant interference scenario may occur due to restricted association. For example, in FIG. 1, UE 120y may be close to femto eNB 110y and may have high received power for eNB 110y. However, UE 120y may not be able to access femto eNB 110y due to restricted association and may then connect to macro eNB 110c with lower received power (as shown in FIG. 1) or to femto eNB 110z also with lower received power (not shown in FIG. 1). UE 120y may then observe high interference from femto eNB 110y on the downlink and may also cause high interference to eNB 110y on the uplink.

A dominant interference scenario may also occur due to range extension, which is a scenario in which a UE connects to an eNB with lower pathloss and lower SNR among all eNBs detected by the UE. For example, in FIG. 1, UE 120x may detect macro eNB 110b and pico eNB 110x and may have lower received power for eNB 110x than eNB 110b. Nevertheless, it may be desirable for UE 120x to connect to pico eNB 110x if the pathloss for eNB 110x is lower than the pathloss for macro eNB 110b. This may result in less interference to the wireless network for a given data rate for UE 120x.

In an aspect, communication in a dominant interference scenario may be supported by having different eNBs operate on different frequency bands. A frequency band is a range of frequencies that may be used for communication and may be given by (i) a center frequency and a bandwidth or (ii) a lower frequency and an upper frequency. A frequency band may also be referred to as a band, a frequency channel, etc. The frequency bands for different eNBs may be selected such that a UE can communicate with a weaker eNB in a dominant interference scenario while allowing a strong eNB to communicate with its UEs. An eNB may be classified as a “weak” eNB or a “strong” eNB based on the received power of signals from the eNB received at a UE (and not based on the transmit power level of the eNB).

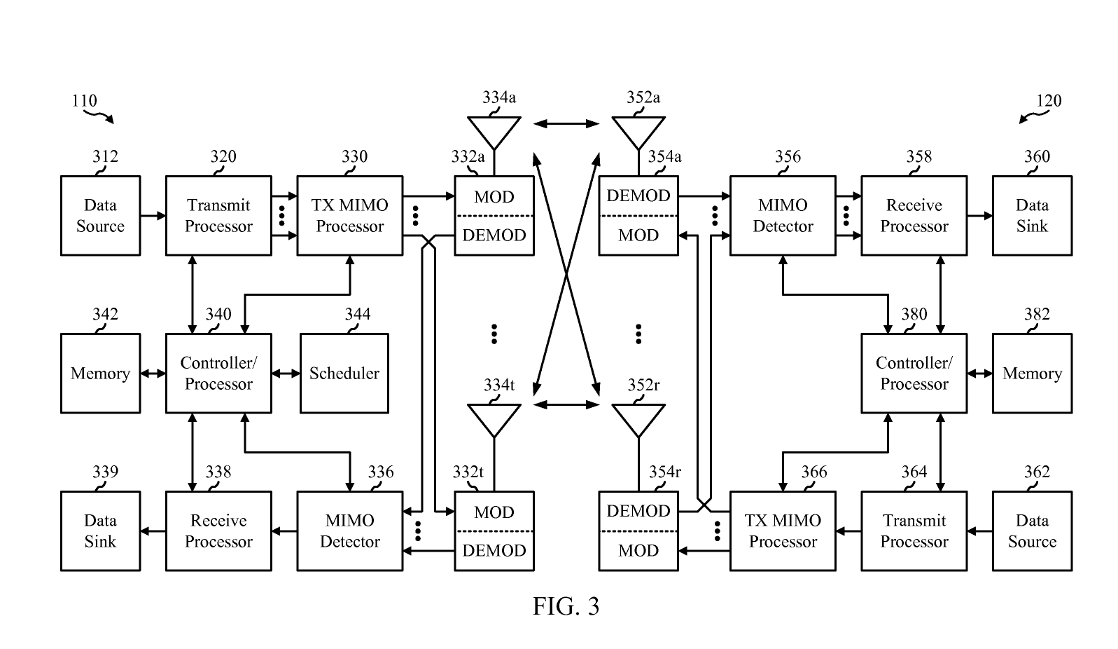

FIG. 3 is a block diagram of a design of a base station or an eNB 110 and a UE 120, which may be one of the base stations/eNBs and one of the UEs in FIG. 1. For a restricted association scenario, the eNB 110 may be macro eNB 110c in FIG. 1, and the UE 120 may be UE 120y. The eNB 110 may also be a base station of some other type. The eNB 110 may be equipped with T antennas 334a through 334t, and the UE 120 may be equipped with R antennas 352a through 352r, where in general T≧1 and R≧1.

At the eNB 110, a transmit processor 320 may receive data from a data source 312 and control information from a controller/processor 340. The control information may be for the PBCH, PCFICH, PHICH, PDCCH, etc. The data may be for the PDSCH, etc. The transmit processor 320 may process (e.g., encode and symbol map) the data and control information to obtain data symbols and control symbols, respectively. The transmit processor 320 may also generate one or more reference symbols, e.g., for one or more reference signals like the PSS, SSS, and cell-specific reference signal. A transmit (TX) multiple-input multiple-output (MIMO) processor 330 may perform spatial processing (e.g., precoding) on the data symbols, the control symbols, and/or the reference symbols, if applicable, and may provide T output symbol streams to T modulators (MODs) 332a through 332t. Each modulator 332 may process a respective output symbol stream (e.g., for OFDM, etc.) to obtain an output sample stream. Each modulator 332 may further process (e.g., convert to analog, amplify, filter, and up-convert) the output sample stream to obtain a downlink signal. T downlink signals from modulators 332a through 332t may be transmitted via T antennas 334a through 334t, respectively.

At the UE 120, antennas 352a through 352r may receive the downlink signals from the eNB 110 and may provide received signals to demodulators (DEMODs) 354a through 354r, respectively. Each demodulator 354 may condition (e.g., filter, amplify, down-convert, and digitize) a respective received signal to obtain input samples. Each demodulator 354 may further process the input samples (e.g., for OFDM, etc.) to obtain received symbols. A MIMO detector 356 may obtain received symbols from all R demodulators 354a through 354r, perform MIMO detection on the received symbols, if applicable, and provide detected symbols. A receive processor 358 may process (e.g., demodulate, deinterleave, and decode) the detected symbols, provide decoded data for the UE 120 to a data sink 360, and provide decoded control information to a controller/processor 380.

On the uplink, at the UE 120, a transmit processor 364 may receive and process data (e.g., for the PUSCH) from a data source 362 and control information (e.g., for the PUCCH) from the controller/processor 380. The transmit processor 364 may also generate one or more reference symbols for one or more reference signals. The symbols from transmit processor 364 may be precoded by a TX MIMO processor 366 if applicable, further processed by modulators 354a through 354r (e.g., for SC-FDM, etc.), and transmitted to the eNB 110. At the eNB 110, the uplink signals from the UE 120 may be received by the antennas 334, processed by the demodulators 332, detected by a MIMO detector 336 if applicable, and further processed by a receive processor 338 to obtain decoded data and control information sent by the UE 120. The receive processor 338 may provide the decoded data to a data sink 339 and the decoded control information to the controller/processor 340.

The controllers/processors 340 and 380 may direct the operation at the eNB 110 and the UE 120, respectively. The controller/processor 340, receive processor 338, transmit processor 320 and/or other processors and modules at the eNB 110 may perform or direct operations and/or processes for the techniques described herein. The controller/processor 380, receive processor 358, transmit processor 364 and/or other processors and modules at the UE 120 may perform or direct operations and/or processes for the techniques described herein. The memories 342 and 382 may store data and program codes for the eNB 110 and the UE 120, respectively. A scheduler 344 may schedule UEs for data transmission on the downlink and/or uplink.

### Example Resource Partitioning

According to certain aspects of the present disclosure, when a network supports enhanced inter-cell interference coordination (eICIC), the base stations may negotiate with each other to coordinate resources in order to reduce or eliminate interference by the interfering cell giving up part of its resources. In accordance with this interference coordination, a UE may be able to access a serving cell even with severe interference by using resources yielded by the interfering cell.

For example, a femto cell with a closed access mode (e.g., in which only a member femto UE can access the cell) in the coverage area of an open macro cell may be able to create a “coverage hole” (in the femto cell's coverage area) for a macro cell by yielding resources and effectively removing interference. By negotiating for a femto cell to yield resources, the macro UE under the femto cell coverage area may still be able to access the UE's serving macro cell using these yielded resources.

In a radio access system using OFDM, such as Evolved Universal Terrestrial Radio Access Network (E-UTRAN), the yielded resources may be time based, frequency based, or a combination of both. When the coordinated resource partitioning is time based, the interfering cell may simply not use some of the subframes in the time domain. When the coordinated resource partitioning is frequency based, the interfering cell may yield subcarriers in the frequency domain. With a combination of both frequency and time, the interfering cell may yield frequency and time resources.

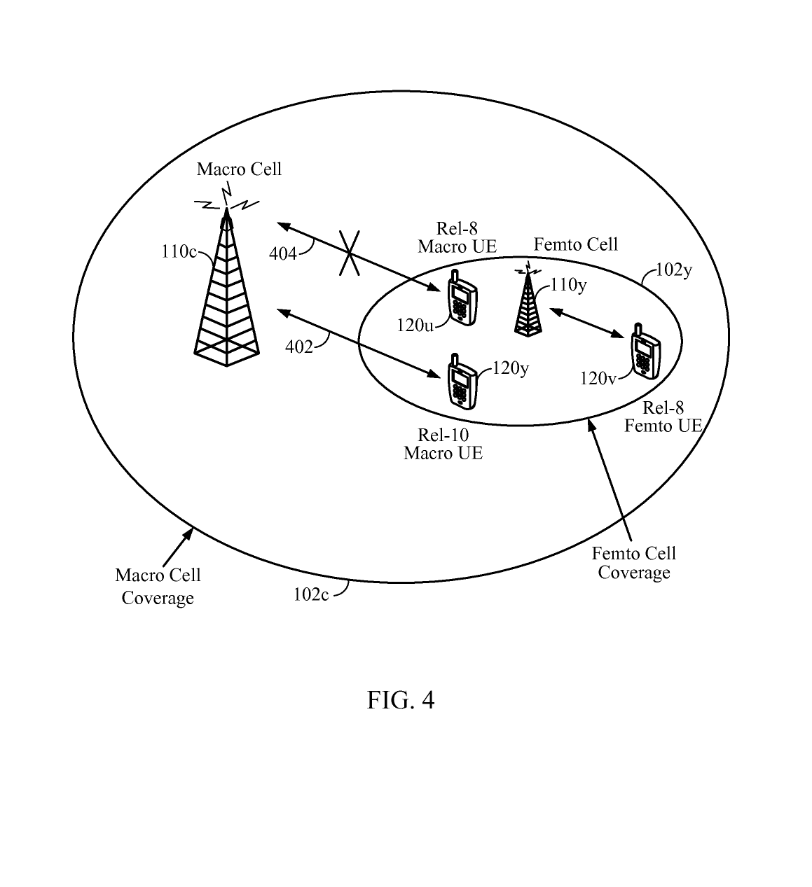

FIG. 4 illustrates an example scenario where eICIC may allow a macro UE 120y supporting eICIC (e.g., a Rel-10 macro UE as shown in FIG. 4) to access the macro cell 110c even when the macro UE 120y is experiencing severe interference from the femto cell y, as illustrated by the solid radio link 402. A legacy macro UE 120u (e.g., a Rel-8 macro UE as shown in FIG. 4) may not be able to access the macro cell 110c under severe interference from the femto cell 110y, as illustrated by the broken radio link 404. A femto UE 120v (e.g., a Rel-8 femto UE as shown in FIG. 4) may access the femto cell 110y without any interference problems from the macro cell 110c.

According to certain aspects, networks may support eICIC, where there may be different sets of partitioning information. A first of these sets may be referred to as Semi-static Resource Partitioning Information (SRPI). A second of these sets may be referred to as Adaptive Resource Partitioning Information (ARPI). As the name implies, SRPI typically does not change frequently, and SRPI may be sent to a UE so that the UE can use the resource partitioning information for the UE's own operations.

As an example, the resource partitioning may be implemented with 8 ms periodicity (8 subframes) or 40 ms periodicity (40 subframes). According to certain aspects, it may be assumed that frequency division duplexing (FDD) may also be applied such that frequency resources may also be partitioned. For communications via the downlink (e.g., from a cell node B to a UE), a partitioning pattern may be mapped to a known subframe (e.g., a first subframe of each radio frame that has a system frame number (SFN) value that is a multiple of an integer N, such as 4). Such a mapping may be applied in order to determine resource partitioning information (RPI) for a specific subframe. As an example, a subframe that is subject to coordinated resource partitioning (e.g., yielded by an interfering cell) for the downlink may be identified by an index:

IndexSRPI_DL=(SFN*10+subframe number) mod 8

For the uplink, the SRPI mapping may be shifted, for example, by 4 ms. Thus, an example for the uplink may be:

IndexSRPI_UL=(SFN*10+subframe number+4) mod 8

SRPI may use the following three values for each entry:
U (Use): this value indicates the subframe has been cleaned up from the dominant interference to be used by this cell (e.g., the main interfering cells do not use this subframe);
N (No Use): this value indicates the subframe shall not be used; and
X (Unknown): this value indicates the subframe is not statically partitioned. Details of resource usage negotiation between base stations are not known to the UE.

Another possible set of parameters for SRPI may be the following:
U (Use): this value indicates the subframe has been cleaned up from the dominant interference to be used by this cell (i.e., the main interfering cells do not use this subframe);
N (No Use): this value indicates the subframe shall not be used;
X (Unknown): this value indicates the subframe is not statically partitioned (and details of resource usage negotiation between base stations are not known to the UE); and
C (Common): this value may indicate all cells may use this subframe without resource partitioning. This subframe may be subject to interference, so that the base station may choose to use this subframe only for a UE that is not experiencing severe interference.

The serving cell's SRPI may be broadcasted over the air. In E-UTRAN, the SRPI of the serving cell may be sent in a master information block (MIB), or one of the system information blocks (SIBs). A predefined SRPI may be defined based on the characteristics of cells, e.g. macro cell, pico cell (with open access), and femto cell (with closed access). In such a case, encoding of SRPI in the system overhead message may result in more efficient broadcasting over the air.

The base station may also broadcast the neighbor cell's SRPI in one of the SIBs. For this, SRPI may be sent with its corresponding range of physical cell identifiers (PCIs).

ARPI may represent further resource partitioning information with the detailed information for the ‘X’ subframes in SRPI. As noted above, detailed information for the ‘X’ subframes is typically only known to the base stations, and a UE does not know it.

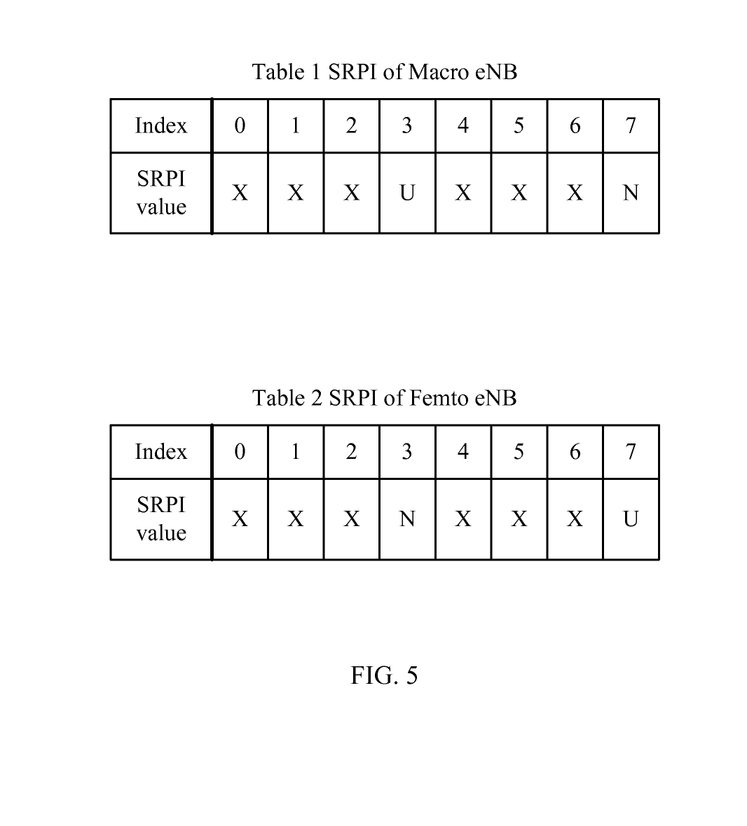

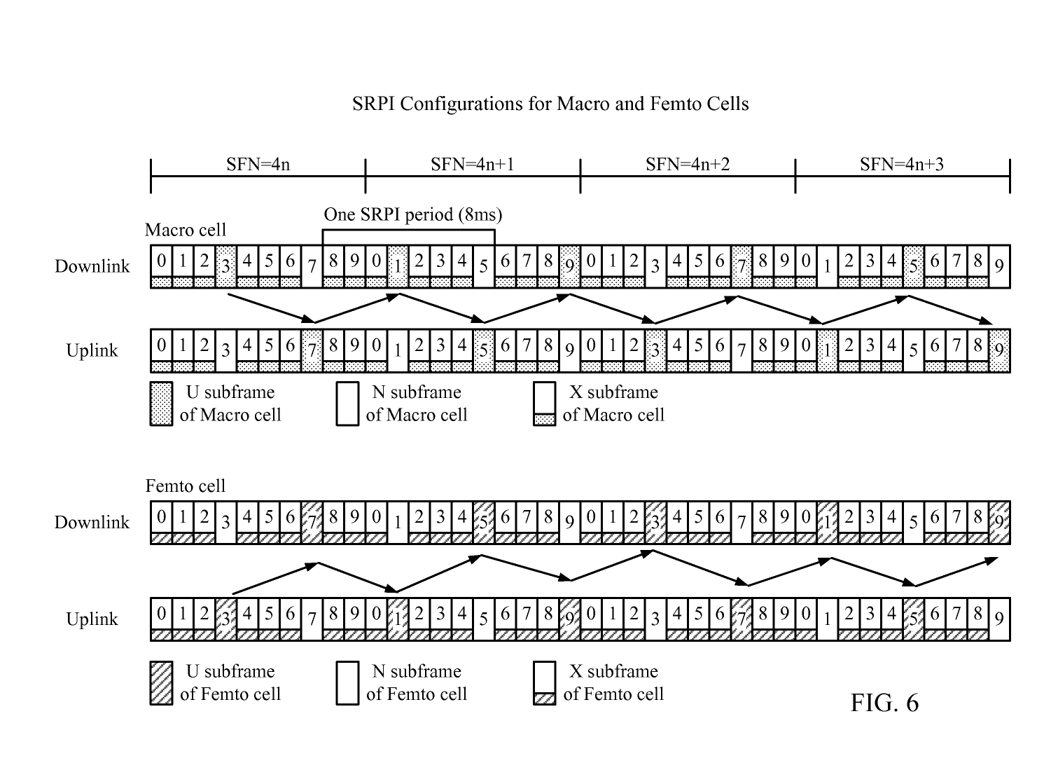

FIGS. 5 and 6 illustrate examples of SRPI assignment in the scenario with macro and femto cells. A U, N, X, or C subframe is a subframe corresponding to a U, N, X, or C SRPI assignment.

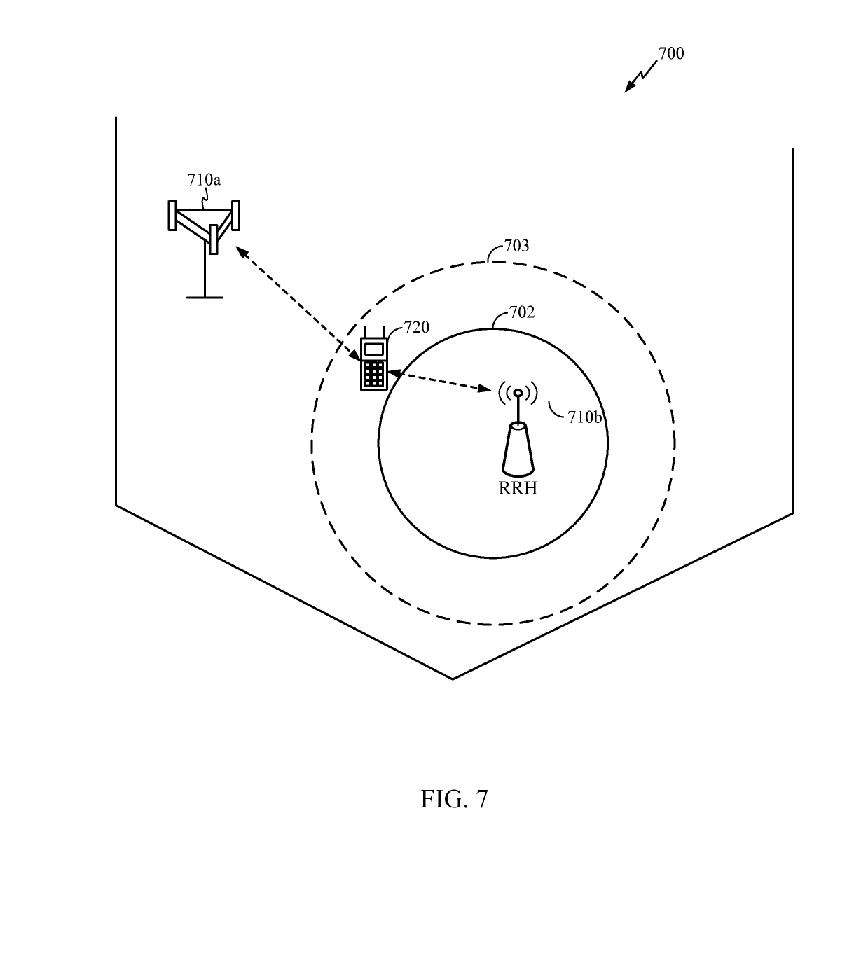

FIG. 7 is a diagram 700 illustrating a range expanded cellular region in a heterogeneous network. A lower power class eNB such as the RRH 710b may have a range expanded cellular region 703 that is expanded from the cellular region 702 through enhanced inter-cell interference coordination between the RRH 710b and the macro eNB 710a and through interference cancelation performed by the UE 720. In enhanced inter-cell interference coordination, the RRH 710b receives information from the macro eNB 710a regarding an interference condition of the UE 720. The information allows the RRH 710b to serve the UE 720 in the range expanded cellular region 703 and to accept a handoff of the UE 720 from the macro eNB 710a as the UE 720 enters the range expanded cellular region 703.

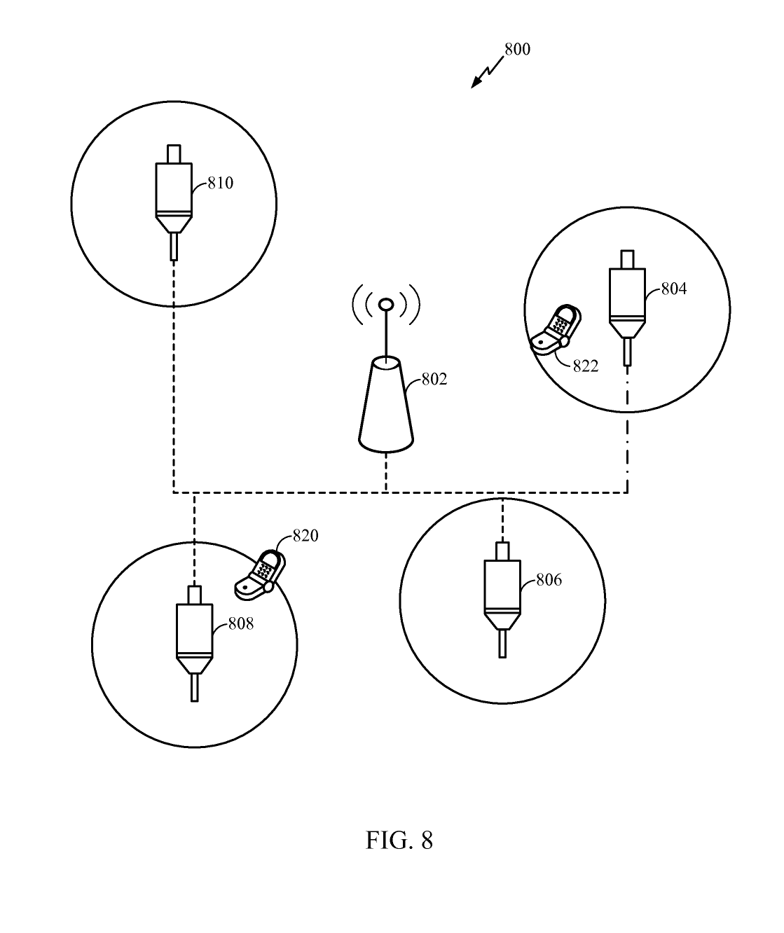

FIG. 8 is a diagram illustrating a network 800, which includes a macro node and a number of remote radio heads (RRHs) in accordance with certain aspects of the present disclosure. The macro node 802 may be coupled to RRHs 804, 806, 808, and 810 with optical fiber. In certain aspects, network 800 may be a homogeneous network or a heterogeneous network and the RRHs 804-810 may be low power or high power RRHs. In an aspect, the macro node 802 handles all scheduling within the cell, for itself and the RRHs. The RRHs may be configured with the same cell identifier (ID) as the macro node 802 or with different cell IDs. If the RRHs are configured with the same cell ID, the macro node 802 and the RRHs may operate as essentially one cell controlled by the macro node 802. On the other hand, if the RRHs and the macro node 802 are configured with different cell IDs, the macro node 802 and the RRHs may appear to a UE as different cells, though all control and scheduling may still remain with the macro node 802. It should further be appreciated that the processing for the macro node 802 and the RRHs 804, 806, 808, 810 may not necessarily have to reside at the macro node. It may also be performed in a centralized fashion at some other network device or entity that is connected with the macro and the RRHs.

As used herein, the term transmission/reception point (“TxP”) generally refers to geographically separated transmission/reception nodes controlled by at least one central entity (e.g., eNodeB), which may have the same or different cell IDs.

In certain aspects, when each of the RRHs share the same cell ID with the macro node 802, control information may be transmitted using CRS from the macro node 802 or both the macro node 802 and all of the RRHs. The CRS is typically transmitted from each of the transmission points using the same resource elements, and therefore the signals collide. When each of the transmission points has the same cell ID, CRS transmitted from each of the transmission points may not be differentiated. In certain aspects, when the RRHs have different cell IDs, the CRS transmitted from each of the TxPs using the same resource elements may or may not collide. Even in the case, when the RRHs have different cell IDs and the CRS collide, advanced UEs may differentiate CRS transmitted from each of the TxPs using interference cancellation techniques and advanced receiver processing.

In certain aspects, when all transmission points are configured with the same cell ID and CRS is transmitted from all transmission points, proper antenna virtualization is needed if there are an unequal number of physical antennas at the transmitting macro node and/or RRHs. That is, CRS is to be transmitted with an equal number of CRS antenna ports. For example, if the node 802 and the RRHs 804, 806, 808 each have four physical antennas and the RRH 810 has two physical antennas, a first antenna of the RRH 810 may be configured to transmit using two CRS ports and a second antenna of the RRH 810 may be configured to transmit using a different two CRS ports. Alternatively, for the same deployment, macro 802 and RRHs 804, 806, 808, may transmit only two CRS antenna ports from selected two out of the four transmit antennas per transmission point. Based on these examples, it should be appreciated that the number of antenna ports may be increased or decreased in relation to the number of physical antennas.

As discussed supra, when all transmission points are configured with the same cell ID, the macro node 802 and the RRHs 804-810 may all transmit CRS. However, if only the macro node 802 transmits CRS, outage may occur close to an RRH due to automatic gain control (AGC) issues. In such a scenario, CRS based transmission from the macro 802 may be received at low receive power while other transmissions originating from the close-by RRH may be received at much larger power. This power imbalance may lead to the aforementioned AGC issues.

In summary, typically, a difference between same/different cell ID setups relates to control and legacy issues and other potential operations relying on CRS. The scenario with different cell IDs, but colliding CRS configuration may have similarities with the same cell ID setup, which by definition has colliding CRS. The scenario with different cell IDs and colliding CRS typically has the advantage compared to the same cell ID case that system characteristics/components which depend on the cell ID (e.g., scrambling sequences, etc.) may be more easily differentiated.

The exemplary configurations are applicable to macro/RRH setups with same or different cell IDs. In the case of different cell IDs, CRS may be configured to be colliding, which may lead to a similar scenario as the same cell ID case but has the advantage that system characteristics which depend on the cell ID (e.g., scrambling sequences, etc.) may be more easily differentiated by the UE).

In certain aspects, an exemplary macro/RRH entity may provide for separation of control/data transmissions within the transmission points of this macro/RRH setup. When the cell ID is the same for each transmission point, the PDCCH may be transmitted with CRS from the macro node 802 or both the macro node 802 and the RRHs 804-810, while the PDSCH may be transmitted with channel state information reference signal (CSI-RS) and demodulation reference signal (DM-RS) from a subset of the transmission points. When the cell ID is different for some of the transmission points, PDCCH may be transmitted with CRS in each cell ID group. The CRS transmitted from each cell ID group may or may not collide. UEs may not differentiate CRS transmitted from multiple transmission points with the same cell ID, but may differentiate CRS transmitted from multiple transmission points with different cell IDs (e.g., using interference cancellation or similar techniques).

In certain aspects, in the case where all transmission points are configured with the same cell ID, the separation of control/data transmissions enables a UE transparent way of associating UEs with at least one transmission point for data transmission while transmitting control based on CRS transmissions from all the transmission points. This enables cell splitting for data transmission across different transmission points while leaving the control channel common. The term “association” above means the configuration of antenna ports for a specific UE for data transmission. This is different from the association that would be performed in the context of handover. Control may be transmitted based on CRS as discussed supra. Separating control and data may allow for a faster reconfiguration of the antenna ports that are used for a UE's data transmission compared to having to go through a handover process. In certain aspects, cross transmission point feedback may be possible by configuring a UE's antenna ports to correspond to the physical antennas of different transmission points.

In certain aspects, UE-specific reference signals enable this operation (e.g., in the context of LTE (e.g., LTE-A, Rel-10 and above). CSI-RS and DM-RS are the reference signals used in the LTE-A context. Interference estimation may be carried out based on or facilitated by CSI-RS muting. When control channels are common to all transmission points in the case of a same cell ID setup, there may be control capacity issues because PDCCH capacity may be limited. Control capacity may be enlarged by using FDM control channels. Relay PDCCH (R-PDCCH) or extensions thereof, such as an enhanced PDCCH (ePDCCH) may be used to supplement, augment, or replace the PDCCH control channel.

### Example Resource Management

Common reference signals (CRS), used in LTE Release 8 are used for many purposes, for example, timing tracking, frequency tracking, channel estimation, mobility management (e.g., reference signal received power (RSRP)/reference signal received quality (RSRQ) report), channel state information (CSI) feedback, etc. The CRS bandwidth assumed for the above operations is generally wideband (e.g., same as downlink system bandwidth), or, in some cases, a small bandwidth in the center (e.g., 1.4 MHz in the center).

In Release 10, CRS starts to become de-prioritized. Instead, new reference signals are introduced with dedicated purposes for more efficient UE-specific operations or functions. Examples of channels with dedicated purposes include: in Release 10, CSI-RS for channel estimation in CSI feedback; in Release-11, interference measurements resource (IMR) based on the Release 10 CSI-RS resource configurations with muted (zero-power) CSI-RS transmissions; also in Release-11, CSI-RS may also be used for timing tracking, combined with CRS, or demodulation reference signal (DM-RS), where a UE may be indicated where the relevant reference signals are pseudo co-located; in future releases, CSI-RS may also be for mobility management

In heterogeneous networks, cells of different power classes co-exist. Cell range expansion (CRE) may be enabled to expand the coverage area of lower power class nodes for better cell offload and cell splitting. However, UEs in CRE lower power class nodes (e.g., Pico cell) may experience overwhelming interference from high power class nodes (e.g., Macro cell).

Time-domain interference coordination between cells is necessary. For example, almost blank subframes (ABS) can be configured by higher power class nodes to minimize interference to CREs served by lower power class nodes. In these subframes, higher power class nodes may not transmit any unnecessary signals or transmit only signals with greatly reduced power (e.g., only CRS is transmitted for backward compatibility).

Interference cancellation (e.g., such as cancellation of CRS from higher power class nodes) may become necessary at CRE UE for proper mobility management, CSI feedback, demodulation, etc.

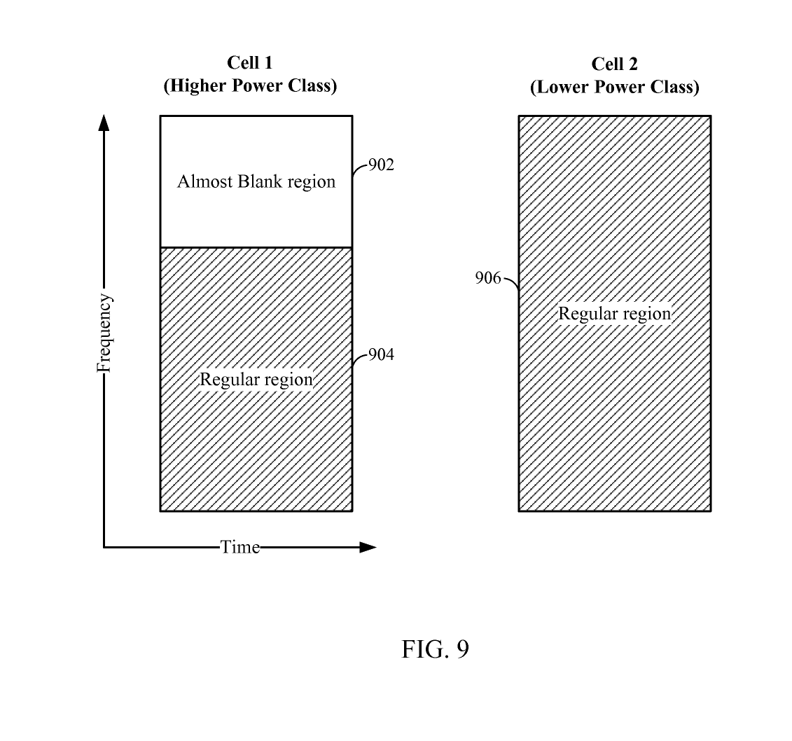

Besides time domain interference coordination, frequency domain interference domain is also possible, as shown in FIG. 9. Higher power cells (Cell 1) may transmit as usual (or with a bit lower power) in some fraction of the bandwidth (Regular region 904), and may not transmit any non-necessary signals or only transmits with some minimal transmission (potentially with much lower power) in some other fraction of the bandwidth (Almost Blank region 902) for the benefits of a neighboring cell. A lower power cell (Cell 2) may transmit as usual (or with a bit lower power) in the entire bandwidth (Regular region 906).

Frequency domain interference domain between different cells may involve both control channels and data channels including, for example, physical downlink shared channel (PDSCH) and enhanced physical downlink control channel (ePDCCH). ePDCCH is a new control introduced in LTE Rel-11, and it is based on a pure frequency-division multiplexing (FDM) structure (e.g., each ePDCCH transmission substantially utilizes the entire subframe duration). ePDCCH is typically power controlled, and its resource granularity is smaller than physical resource block (PRB), for example, as in the PDSCH case.

Frequency domain interference coordination may result in overwhelming interference to some transmissions (e.g., reference signals) in some fraction of the bandwidth. Particularly to CRS of lower power class nodes when the interfering cell has non-colliding CRS (e.g., different CRS shifts). Such frequency domain interference is frequency-dependent and subframe-dependent.

If the interference is due to PDSCH, the minimum resource granularity is one RB in a slot, for example. If the interference is due to ePDCCH, the minimum resource granularity, for example, is one enhanced resource element group (eREG) or enhanced control channel element (eCCE), both are a fraction of a PRB pair over a subframe. The subframe dependency occurs because serving cells may have multi-broadcast single frame network (MBSFN) subframes (CRS is absent from the MBSFN region of the subframe) or non-MBSFN subframes. The presence of ePDCCH is generally subframe dependent, etc.

Accordingly, what is needed are techniques and apparatus for improving resource management.

In order to address the issues, a UE may indicate a set of RBs and a set of subframes that are “non-usable” (e.g., subject to heavy interference). The indication can be static, semi-static or dynamic. The set of RBs can be the same for all subframes in the set, but can be different as well (e.g., subframe-dependent “non-usable” RBs). According to embodiments, signaling may be unicast, multicast and/or broadcast. Although resource granularity of RB is preferable, other resource granularity is possible as well, for example, eREG or eCCE granularity.

A UE may indicate a first set of RB or subframes for a first purpose and a second set of RB or subframes for a second purpose (e.g., feature-dependent or function-dependent “non-usable” RBs and/or subframes). For example, the eNB may broadcast a first set of RB or subframes including no “non-usable” indication for mobility management. The eNB may further unicast a second set of RB or subframes for CSI feedback and channel estimation.

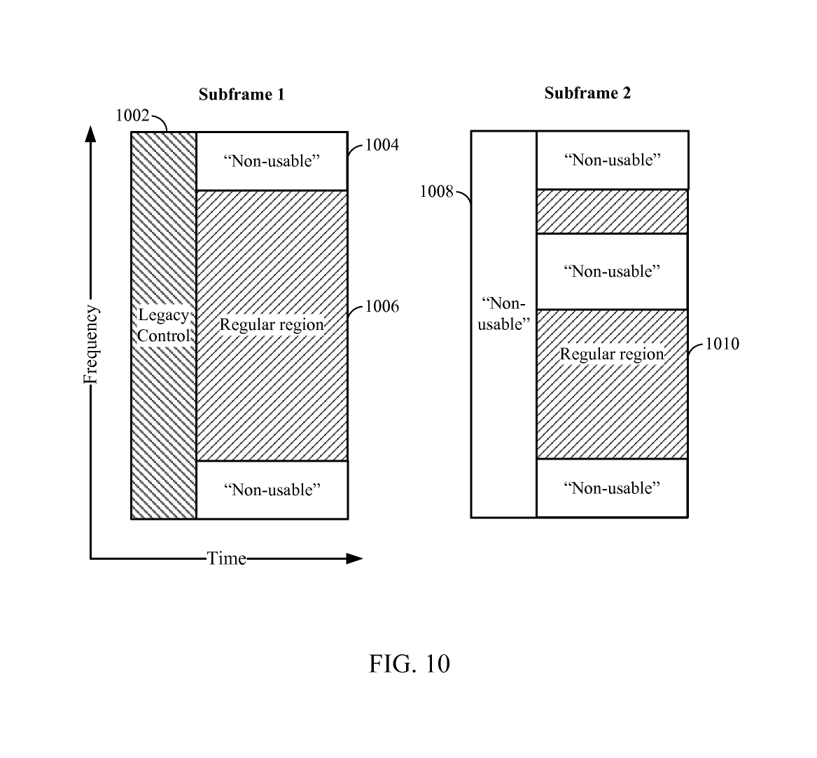

FIG. 10 provides a diagram illustrating subframe-dependent “non-usable” RBs. In subframe 1, interfering cell(s) have transmissions in the legacy control 1002, and may have limited transmissions on the two edges in the non-usable region 1004 and regular transmissions in the regular region 1006 between the edges. In subframe 2, interfering cell(s) may have limited or no transmissions in legacy control region, on the edges, and in the middle of the data region 1008, and regular transmissions in the regular region 1010.

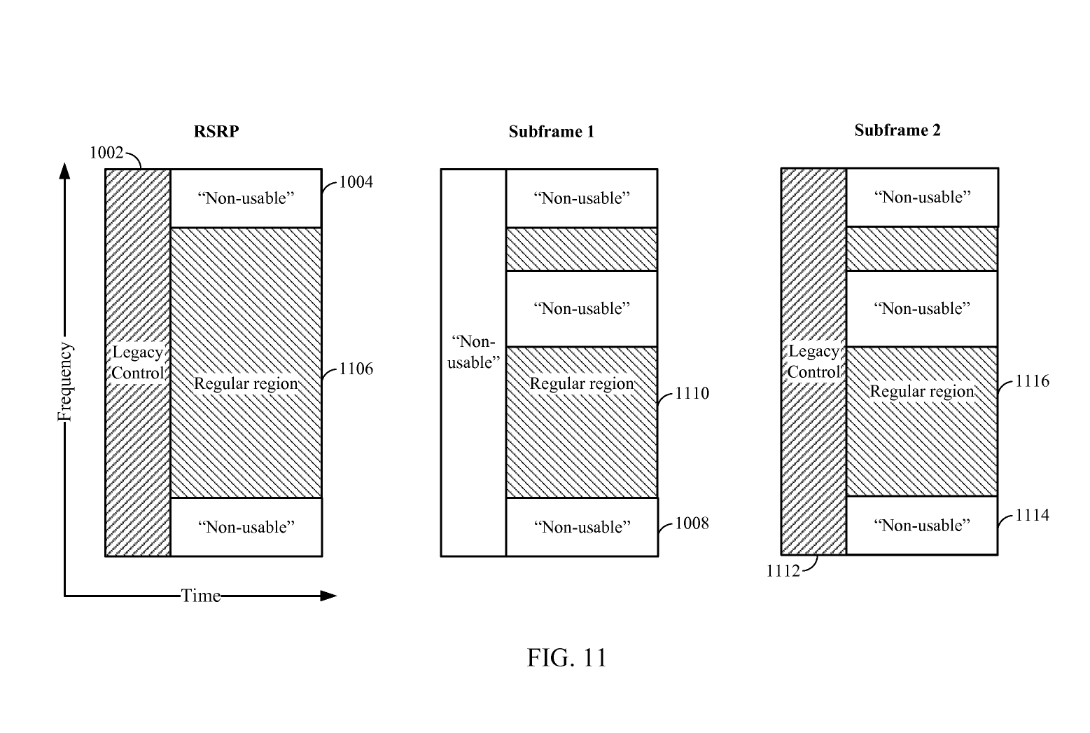

FIG. 11 provides a diagram illustrating examples of feature-dependent “non-usable” RBs or subframes. For reference signal receive power (RSRP), the set of “non-usable” RBs can be subframe-independent, and can be semi-statically or statically determined For channel estimation, the set of “non-usable” RBs can be subframe-dependent, and can have different sets of “non-usable” RBs.

This can be used for many purposes or functions, such as mobility management (e.g., RSRP, reference signal receive quality (RSRQ)), demodulation (e.g., wide-band channel estimation would exclude the “non-usable” RBs), CSI feedback (e.g., for a given set S for CSI measurement, the UE further excludes certain resources in the set S for CSI measurement), time/frequency tracking (e.g., discount the “non-usable” RBs/subframes for the tracking), etc.

For aspects in which resource management includes reference signal resource management, the reference signal is not limited to CRS, but can be applied to other type of RS signals as well. For example, “non-desirable” or “non-usable” RBs or subframes 1104 for SRS may be indicated such that the UE can omit transmissions from these RBs in a subframe, or “non-desirable” or “non-usable” RBs or subframes for CSI-RS may be indicated such that the UE can omit measurement based on CSI-RS in these RBs in a subframe. Regular transmissions may be in the regular region 1106. In subframe 1, the legacy control region, the edges, and the middle of the data region may be non-usable 1108, the rest of the data region may have regular transmissions 1110. In subframe 2, the legacy control region 1112 and portions of the data region may have regular transmissions 1116, and the edges and a portion of the data region may be non-usable 1114.

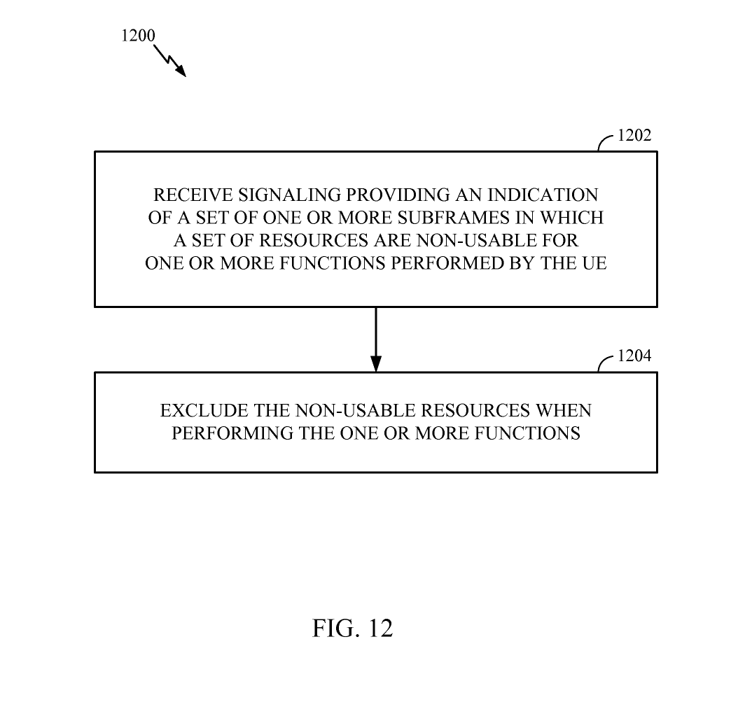

FIG. 12 illustrates example operations 1200 that may be performed by a user equipment (UE), according to certain aspects of the present disclosure. The operations begin, at 1202, by receiving signaling providing an indication of a set of one or more subframes in which a set of resources are non-usable (e.g., as reference signals) for one or more functions performed by the UE. In aspects, the signaling may provide an indication of a fraction of one or more portions of a resource block of one or more subframes, or one or more subframes as non-usable for one or more functions performed by the UE. At 1204, the UE excludes the non-usable resources when performing the one or more functions (e.g., mobility management, demodulation, CSI feedback, time tracking, frequency tracking, and the like).

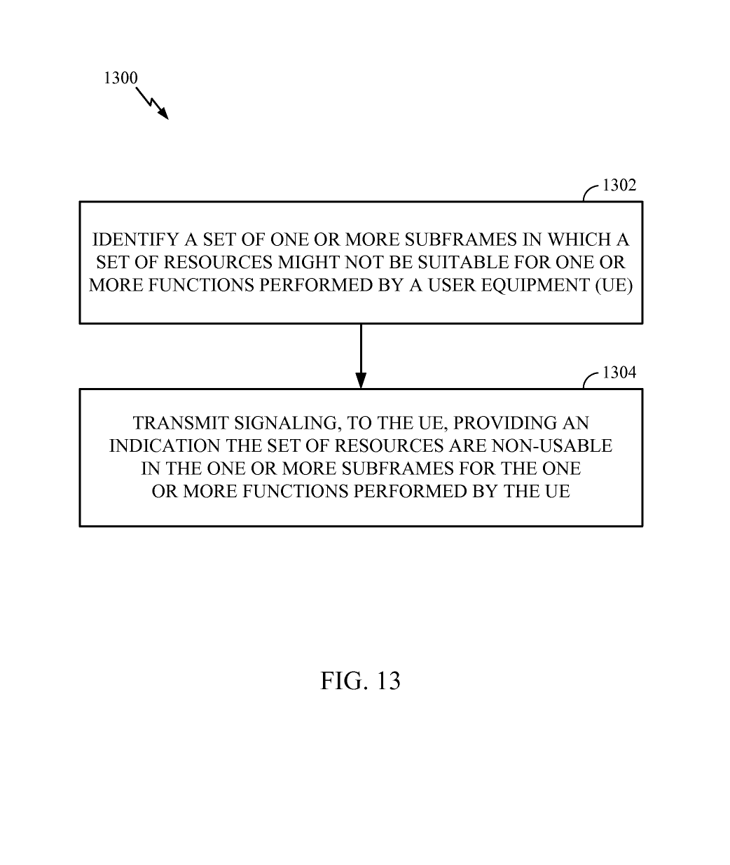

FIG. 13 illustrates example operations that may be performed by a base station (BS), according to certain aspects of the present disclosure. The operations begin, at 1302, by identifying a set of one or more subframes in which a set of resources might not be suitable (e.g., as reference signals) for one or more functions performed by a user equipment (UE). In aspects, the signaling may provide an indication of a fraction of one or more portions of a resource block of one or more subframes, or one or more subframes as non-usable for one or more functions performed by the UE. At 1303, the BS transmits signaling, to the UE, providing an indication the set of resources are non-usable (e.g., as reference signals) in the one or more subframes for one or more functions performed by the UE.

In some embodiments, a subset of resources containing wideband RS may be used for some measurements at the UE due to potential FDM based interference management in Hetnet.

### Alternate Examples

For PDSCH and ePDCCH starting symbol position, the current agreement is to have PDSCH and ePDCCH aligned in the same subframe. In Releases 8-11, the UE follows physical control format indicator channel (PCFICH). In Release 11, the UE follows the RRC signal. In RAN1, whenever there is RRC signaling, the RRC signal will overwrite the PCFICH values. For common search space, the UE will monitor PCFICH and PDCCH. However, there are many subframes that the UE is required to monitor in common search space. Also, the UE must rely on PCFICH to decide the starting position of PDSCH.

According to certain aspects, when the UE is RRC signaled for the starting symbol position, and overwrites the PCFICH for the subframe, it has to apply the following exceptions for some or all of the following events, where the UE will instead follow the PCFICH for starting symbol (i.e., event dependent priority handling between RRC signaled starting point versus a PCFICH determined starting point): system information block (SIB) transmissions, for paging occasions (e.g., subframes 0, 4, 5, 9), and connected mode contention-based RACH, for the RACH response time window.

Those of skill in the art would understand that information and signals may be represented using any of a variety of different technologies and techniques. For example, data, instructions, commands, information, signals, bits, symbols and chips that may be referenced throughout the above description may be represented by voltages, currents, electromagnetic waves, magnetic fields or particles, optical fields or particles, or any combination thereof.

### Example Radio Link Monitoring Based on PDCCH and/or ePDCCH for LTE

In some cases, resource management techniques, such as those described above, may be used to determine what resources to consider for radio link monitoring (RLM) procedures. For example, such a decision may involve decide what type(s) of downlink control channels RLM should be based on (e.g., conventional/legacy PDCCH or enhanced EPDCCH).

In cellular networks, mobile phones (e.g., user equipments (UEs)) may evaluate the quality of the physical link, for example by performing radio link monitoring (RLM). RLM is typically based on common reference signal (CRS) quality measurements. In the conventional CRS based approach, the UE may translate CRS signal quality into estimated physical downlink control channel (PDCCH) error rate on a subframe basis and average block error rate (BLER) on PDCCH. If the link has degraded beyond a certain point, the UE sends an out-of-sync (OOS) notification to the upper layers. If the link quality improves beyond a certain threshold, the UE sends an in-sync (IS) indication. Based on the OOS notification, the upper layers declare radio link failure (RLF) and halt all transmissions. After RLF, the UE attempts to reestablish a connection to the network.

In long-term evolution (LTE), the thresholds for OOS and IS are defined based on the BLER of the PDCCH. The UE estimates the PDCCH BLER based on signal-to-interference plus noise ratio (SINR) to decide whether to send an OOS or IS to upper layers.

In Rel.11, an enhanced control channel (ePDCCH) is introduced. One difference between PDCCH and ePDCCH is that while PDCCH uses the entire channel bandwidth, ePDCCH is transmitted only in certain subbands and in different parts of the subframe (in time domain). Thus, for non-uniform interference profiles in frequency/time, PDCCH and ePDCCH may have different SINR and different BLER. If OOS and IS are defined for ePDCCH, the UE can declare OOS based on PDCCH, may still achieve decoding performance on ePDCCH such that ePDCCH based OOS is not declared.

OOS and IS thresholds are defined in the standard (3GPP TS 36.133) based on the hypothetical BLER of PDCCH. The UE estimates the BLER based on SINR estimation. To estimate the SINR, the UE uses the pilot signals (e.g., cell-specific reference signals (CRS)) or other signals. If the UE is not scheduled PDCCH, the UE may not compute the PDCCH BLER based directly on PDCCH error rate observations. In that case, radio link monitoring (RLM) based on enhanced control channels may be performed for assessing link quality.

In addition to conventional RLM in LTE based on PDCCH, the UE may also perform RLM based on ePDCCH. In some embodiments, the network may configure which control channel to use for RLM. In some embodiments, the UE may autonomously select a control channel to use for RLM. For example, the UE may decide which control channel is more appropriate based on the interference profile observed.

In some embodiments, the UE may perform RLM on both PDCCH and ePDCCH and declare OOS only when both thresholds (PDCCH and ePDCCH based) are passed. The IS indication may also be based on PDCCH and/or ePDCCH.

In some embodiments, if UL connectivity is maintained, the UE may report to the eNB that one of the thresholds for OOS was passed, and to use the other control channel.

In some embodiments, the UE uses UE-specific pilot signals (e.g., demodulated reference signals (DM-RS)) to estimate the ePDCCH BLER if a common search space is used for ePDCCH. The eNB may also send ePDCCH to the UE, for example, such that the UE can estimate the BLER.

In some embodiments, a Qin and Qout threshold may be based on RS measurements within a specific subband mapped to ePDCCH. Qin and Qout may be defined by 3GPP TS 36.133. Alternatively, Qin and Qout may be defined differently.

In some embodiments, the RLM procedure may performed with the resource management procedure discussed above by indicating a set of RBs and a set of subframes as “usable” or “non-usable” for RLM.

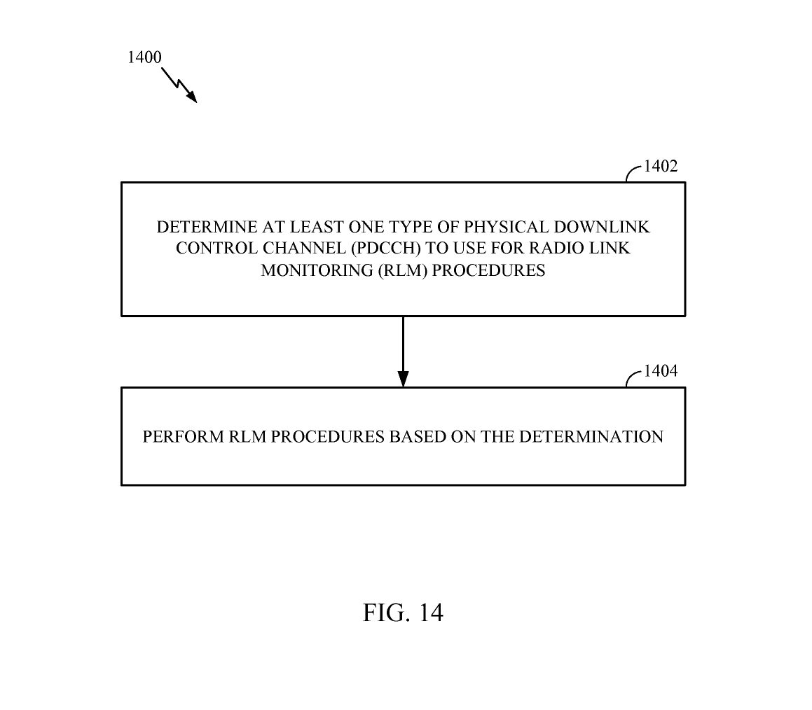

FIG. 14 illustrates example operations 1400 that may be performed by a user equipment (UE), according to certain aspects of the present disclosure. The operations begin, at 1402, by determining at least one type of physical downlink control channel (PDCCH) to use for radio link monitoring (RLM) procedures. In some embodiments, the UE may receive signaling indicating whether to use PDCCH or ePDCCH. In other embodiments, the UE may autonomously decide whether to use PDCCH, ePDCCH, or both, for example, based on an interference profile. At 1404, the UE may perform RLM procedures based on the determination. The UE may estimate BLERs for the determined channels based on SINR. Based on the BLERs, the UE may send on OOS or IS indication to higher levels which may be used by the higher level, for example, to declare RLF is OOS is received.

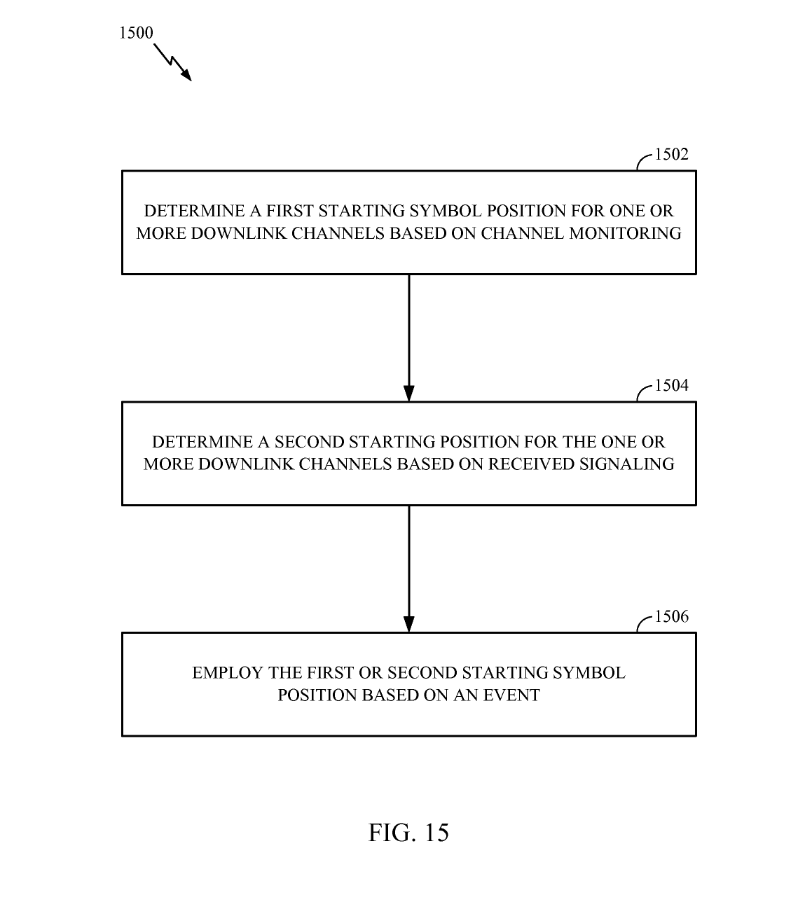

FIG. 15 illustrates example operations 1500 that may be performed by a user equipment (UE), according to certain aspects of the present disclosure. The operations begin, at 1502, by determining a first starting symbol position for one or more downlink channels based on channel monitoring. At 1504, the UE may determine a second starting position for the one or more downlink channels based on received signaling.

At 1506, the UE may employ the first or second starting symbol position based on an event. In some embodiments, the event may be a SIB transmission and the first starting symbol position may be used. Alternatively, the event may be a paging occasion and the first starting symbol position may be used. In some embodiments, the event may be a RACH UE response time window during a contention-based RACH procedure and the first starting symbol position may be used.

Those of skill would further appreciate that the various illustrative logical blocks, modules, circuits and algorithm steps described in connection with the disclosure herein may be implemented as electronic hardware, computer software, or combinations of both. To clearly illustrate this interchangeability of hardware and software, various illustrative components, blocks, modules, circuits and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

The various illustrative logical blocks, modules, and circuits described in connection with the disclosure herein may be implemented or performed with a general-purpose processor, a digital signal processor (DSP), an application specific integrated circuit (ASIC), a field programmable gate array (FPGA) or other programmable logic device, discrete gate or transistor logic, discrete hardware components or any combination thereof designed to perform the functions described herein. A general-purpose processor may be a microprocessor, but in the alternative, the processor may be any conventional processor, controller, microcontroller or state machine. A processor may also be implemented as a combination of computing devices, e.g., a combination of a DSP and a microprocessor, a plurality of microprocessors, one or more microprocessors in conjunction with a DSP core, or any other such configuration.

As used herein, a phrase referring to “at least one of” a list of items refers to any combination of those items, including single members. As an example, “at least one of: a, b, or c” is intended to cover: a, b, c, a-b, a-c, b-c, and a-b-c.

The steps of a method or algorithm described in connection with the disclosure herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM or any other form of storage medium known in the art. An exemplary storage medium is coupled to the processor such that the processor can read information from, and/or write information to, the storage medium. In the alternative, the storage medium may be integral to the processor. The processor and the storage medium may reside in an ASIC. The ASIC may reside in a user terminal In the alternative, the processor and the storage medium may reside as discrete components in a user terminal Generally, where there are operations illustrated in Figures, those operations may have corresponding counterpart means-plus-function components with similar numbering.

In one or more exemplary designs, the functions described may be implemented in hardware, software, firmware or any combination thereof If implemented in software, the functions may be stored on or transmitted over as one or more instructions or code on a computer-readable medium. Computer-readable media includes both computer storage media and communication media including any medium that facilitates transfer of a computer program from one place to another. A storage media may be any available media that can be accessed by a general purpose or special purpose computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and blu-ray disc where disks usually reproduce data magnetically, while discs reproduce data optically with lasers. Combinations of the above should also be included within the scope of computer-readable media.

The previous description of the disclosure is provided to enable any person skilled in the art to make or use the disclosure. Various modifications to the disclosure will be readily apparent to those skilled in the art, and the generic principles defined herein may be applied to other variations without departing from the spirit or scope of the disclosure. Thus, the disclosure is not intended to be limited to the examples and designs described herein, but is to be accorded the widest scope consistent with the principles and novel features disclosed herein.

What is claimed is:

1. A method for wireless communication by a user equipment (UE), comprising:
receiving signaling providing an indication of a set of one or more subframes in which a set of resources are non-usable for one or more functions performed by the UE; and
excluding the non-usable resources when performing the one or more functions.

2. The method of claim 1, wherein at least one of the one or more functions is radio link monitoring (RLM).

3. The method of claim 1, wherein:
the indication is for a set of resource blocks (RBs) that are non-usable in the set of one or more subframes.

4. The method of claim 1, wherein the signaling comprises at least one of broadcast signaling, multicast signaling or unicast signaling.

5. The method of claim 1, wherein the indication has a granularity of less than a resource block.

6. The method of claim 1, wherein the signaling provides an indication of function-dependent non-usable resources, such that:
a first set of resources of one or more subframes are non-usable for a first function; and
a second set of resources of one or more subframes, different than the first set of resources, are non-usable for a second function.

7. The method of claim 6, wherein:
the first function relates to mobility management; and
the second function relates to at least one of channel state information (CSI) feedback or channel estimation.

8. The method of claim 1, wherein the signaling provides an indication of subframe-dependent non-usable resources, such that:
resources in one location in a first subframe are non-usable for a function; and
resources in the same location in a second subframe are usable for the same function.

9. The method of claim 1, wherein the signaling provides an indication of subframe-independent non-usable resources, such that:
resources in one location in a first subframe are non-useable for a function; and
resources in the same location in a second subframe are non-usable for the same function.

10. The method of claim 1, wherein the one or more functions comprise functions related to at least one of:
mobility management, channel estimation, channel state information feedback, or sounding reference signals.

11. The method of claim 1, wherein the non-usable resources correspond to resources used by one or more transmitting entities for transmitting common reference signals (CRS).

12. The method of claim 1, wherein:
the non-usable resources correspond to resources used by the UE for transmitting sounding reference signals (SRS); and
the UE refrains from transmitting SRS on these resources for the one or more subframes for which these resources are non-usable.

13. The method of claim 1, wherein the signaling provides an indication of a fraction of one or more portions of a resource block of one or more subframes or one or more subframes as non-usable for one or more functions performed by the UE.

14. The method of claim 1, wherein the indication is static, semi-static or dynamic.

15. The method of claim 1, wherein receiving signaling providing an indication of a set of one or more subframes in which a set of resources are non-usable for one or more functions performed by the UE includes receiving signaling providing an indication of a set of one or more subframes in which a set of resources are non-usable as reference signals (RSs) for one or more functions performed by the UE.

16. The method of claim 15, wherein receiving signaling providing an indication of a set of one or more subframes in which a set of resources are non-usable as RSs for one or more functions performed by the UE includes receiving signaling providing an indication of a set of one or more subframes in which a set of resources are non-usable as channel state information reference signals (CSI-RSs) for one or more functions performed by the UE, and wherein the UE does not perform measurement based on CSI-RS in the set of resources in the indicated subframes.

17. A method for wireless communication by a base station (BS), comprising:
identifying a set of one or more subframes in which a set of resources might not be suitable for one or more functions performed by a user equipment (UE); and
transmitting signaling, to the UE, providing an indication the set of resources are non-usable in the one or more subframes for the one or more functions performed by the UE.

18. The method of claim 17, wherein at least one of the one or more functions is radio link monitoring (RLM).

19. The method of claim 17, wherein:
the indication is for a set of resource blocks (RBs) that are non-usable in the set of one or more subframes.

20. The method of claim 17, wherein the signaling comprises at least one of broadcast signaling, multicast signaling or unicast signaling.

21. The method of claim 17, wherein the indication has a granularity of less than a resource block.

22. The method of claim 17, wherein the signaling provides an indication of function-dependent non-usable resources, such that:
a first set of resources of one or more subframes are non-usable for a first function; and
a second set of resources of one or more subframes, different than the first set of resources, are non-usable for a second function.

23. The method of claim 21, wherein:
the first function relates to mobility management; and
the second function relates to at least one of channel state information (CSI) feedback or channel estimation.

24. The method of claim 17, wherein the signaling provides an indication of subframe-dependent non-usable resources, such that:
resources in one location in a first subframe are non-usable for a function; and
resources in the same location in a second subframe are usable for the same function.

25. The method of claim 17, wherein the signaling provides an indication of subframe-independent non-usable resources, such that:
resources in one location in a first subframe are non-usable for a function; and
resources in the same location in a second subframe are non-usable for the same function.

26. The method of claim 17, wherein the one or more functions comprise functions related to at least one of:
mobility management, channel estimation, channel state information feedback, or sounding reference signals.

27. The method of claim 17, wherein the non-usable resources correspond to resources used by one or more transmitting entities for transmitting common reference signals (CRS).

28. The method of claim 17, wherein:
the non-usable resources correspond to resources used by the UE for transmitting sounding reference signals (SRS); and
the UE refrains from transmitting SRS on these resources for the one or more subframes for which these resources are non-usable.

29. The method of claim 17, wherein the signaling provides an indication of a fraction of one or more portions of a resource block of one or more subframes or one or more subframes as non-usable for one or more functions performed by the UE.

30. The method of claim 17, wherein the indication is static, semi-static or dynamic.

31. The method of claim 17, wherein identifying a set of one or more subframes in which a set of resources might not be suitable for one or more functions performed by a user equipment (UE) includes identifying a set of one or more subframes in which a set of resources might not be suitable as reference signals (RSs) for one or more functions performed by a user equipment (UE).

32. A method for wireless communications by a user equipment (UE), comprising:
determining at least one type of physical downlink control channel (PDCCH) to use for radio link monitoring (RLM) procedures; and
performing RLM procedures based on the determination.

33. The method of claim 32, wherein the at least one type of PDCCH comprises at least one of a regular PDCCH or an enhanced PDCCH (ePDCCH).

34. The method of claim 32, wherein the determining comprises receiving signaling indicating which type of PDCCH to use.

35. The method of claim 32, wherein the determining comprises determining by the UE which control channel to use based on an interference profile.

36. The method of claim 33, wherein PDCCH and ePDCCH are used.

37. The method of claim 33, wherein ePDCCH is used, and wherein performing RLM procedures comprises estimating a block error rate (BLER) for ePDCCH based on demodulation reference signals (DM-RS).

38. The method of claim 36, wherein performing RLM procedures comprises:
estimating a block error rate (BLER) for the PDCCH and ePDCCH; and
sending an out-of-sync indication (OOS) if at least one of the BLER of the PDCCH passes a first threshold or the BLER of the ePDDCH passes a second threshold, or sending an in-sync indication (IS) if at least one of the BLER of the PDCCH does not pass the first threshold or the BLER of the ePDCCH does not pass the second threshold.

39. The method of claim 36, wherein performing RLM procedures comprises:
estimating a signal-to-interference plus noise ratio (SINR) for the PDCCH and ePDCCH; and
sending an out-of-sync indication (OOS) if at least one of the SINR of the PDCCH passes a first threshold or the SINR of the ePDDCH passes a second threshold, or sending an in-sync indication (IS) if at least one of the SINR of the PDCCH does not pass the first threshold or the SINR of the ePDCCH does not pass the second threshold.

40. The method of claim 39, wherein the at least one of the OOS or IS is sent to a higher layer, and wherein the higher layer declares radio link failure (RLF) if the OOS is sent.

41. The method of claim 38, wherein the at least one of the OOS or IS is sent to a higher layer, and wherein the higher layer declares radio link failure (RLF) if the OOS is sent.

42. The method of claim 32, further comprising:
receiving signaling providing an indication of a set of one or more subframes in which a set of resources are non-usable for RLM procedures; and
excluding the non-usable resources when performing the RLM procedures.

43. A method for wireless communication by a user equipment (UE), comprising:
determining a first starting symbol position for one or more downlink channels based on channel monitoring;
determining a second starting position for the one or more downlink channels based on received signaling; and
employing the first or second starting symbol position based on an event.

44. The method of claim 43, wherein:
the event is a SIB transmission; and
employing the first or second starting symbol position based on an event includes employing the first starting symbol position.

45. The method of claim 43, wherein:
the event is a paging occasion; and
employing the first or second starting symbol position based on an event includes employing the first starting symbol position.

46. The method of claim 43, wherein:
the event is a RACH UE response time window during a contention-based RACH procedure; and
employing the first or second starting symbol position based on an event includes employing the first starting symbol position.

47. An apparatus for wireless communication by a user equipment (UE), comprising:
means for receiving signaling providing an indication of a set of one or more subframes in which a set of resources are non-usable for one or more functions performed by the UE; and
means for excluding the non-usable resources when performing the one or more functions.

48. The apparatus of claim 47, wherein the signaling provides an indication of subframe-dependent non-usable resources, such that:
resources in one location in a first subframe are non-usable for a function; and
resources in the same location in a second subframe are usable for the same function.

49. An apparatus for wireless communication by a user equipment (UE), comprising:
at least one processor configured to:
receive signaling providing an indication of a set of one or more subframes in which a set of resources are non-usable for one or more functions performed by the UE; and
exclude the non-usable resources when performing the one or more functions; and
a memory coupled with the at least one processor.

50. The apparatus of claim 49, wherein the signaling provides an indication of subframe-dependent non-usable resources, such that:
resources in one location in a first subframe are non-usable for a function; and
resources in the same location in a second subframe are usable for the same function.

51. A computer program product, comprising:
a computer-readable medium comprising code for:
receiving signaling providing an indication of a set of one or more subframes in which a set of resources are non-usable for one or more functions performed by the UE; and
excluding the non-usable resources when performing the one or more functions.

52. The computer program product of claim 51, wherein the signaling provides an indication of subframe-dependent non-usable resources, such that:
resources in one location in a first subframe are non-usable for a function; and
resources in the same location in a second subframe are usable for the same function.

53. An apparatus for wireless communication by a base station (BS), comprising:
means for identifying a set of one or more subframes in which a set of resources might not be suitable for one or more functions performed by a user equipment (UE); and
means for transmitting signaling, to the UE, providing an indication the set of resources are non-usable in the one or more subframes for the one or more functions performed by the UE.

54. The apparatus of claim 53, wherein the signaling provides an indication of subframe-dependent non-usable resources, such that:
resources in one location in a first subframe are non-usable for a function; and
resources in the same location in a second subframe are usable for the same function.

55. An apparatus for wireless communication by a base station (BS), comprising:
at least one processor configured to:
identify a set of one or more subframes in which a set of resources might not be suitable for one or more functions performed by a user equipment (UE); and
transmit signaling, to the UE, providing an indication the set of resources are non-usable in the one or more subframes for the one or more functions performed by the UE; and
a memory coupled with the at least one processor.

56. The apparatus of claim 55, wherein the signaling provides an indication of subframe-dependent non-usable resources, such that:
resources in one location in a first subframe are non-usable for a function; and
resources in the same location in a second subframe are usable for the same function.

57. A computer program product, comprising:
a computer-readable medium comprising code for:
identifying a set of one or more subframes in which a set of resources might not be suitable for one or more functions performed by a user equipment (UE); and
transmitting signaling, to the UE, providing an indication the set of resources are non-usable in the one or more subframes for the one or more functions performed by the UE.

58. The computer program product of claim 57, wherein the signaling provides an indication of subframe-dependent non-usable resources, such that:
resources in one location in a first subframe are non-usable for a function; and
resources in the same location in a second subframe are usable for the same function.

59. An apparatus for wireless communications by a user equipment (UE), comprising:
means for determining at least one type of physical downlink control channel (PDCCH) to use for radio link monitoring (RLM) procedures; and
means for performing RLM procedures based on the determination.

60. The apparatus of claim 59, further comprising:
means for receiving signaling providing an indication of a set of one or more subframes in which a set of resources are non-usable for RLM procedures; and
means for excluding the non-usable resources when performing the RLM procedures.

61. An apparatus for wireless communications by a user equipment (UE), comprising:
at least one processor configured to:
determine at least one type of physical downlink control channel (PDCCH) to use for radio link monitoring (RLM) procedures; and
perform RLM procedures based on the determination; and
a memory coupled with the at least one processor.

62. The apparatus of claim 61, wherein the at least one processor is further configured to:
receive signaling providing an indication of a set of one or more subframes in which a set of resources are non-usable for RLM procedures; and
exclude the non-usable resources when performing the RLM procedures.

63. A computer program product, comprising:
a computer-readable medium comprising code for:
determining at least one type of physical downlink control channel (PDCCH) to use for radio link monitoring (RLM) procedures; and
performing RLM procedures based on the determination.

64. The computer-readable medium of claim 63, further comprising code for:
receiving signaling providing an indication of a set of one or more subframes in which a set of resources are non-usable for RLM procedures; and
excluding the non-usable resources when performing the RLM procedures.

65. An apparatus for wireless communication by a user equipment (UE), comprising:
means for determining a first starting symbol position for one or more downlink channels based on channel monitoring;
means for determining a second starting position for the one or more downlink channels based on received signaling; and
means for employing the first or second starting symbol position based on an event.

66. The apparatus of claim 65, wherein:
the event is a RACH UE response time window during a contention-based RACH procedure; and
employing the first or second starting symbol position based on an event includes employing the first starting symbol position.

67. An apparatus for wireless communication by a user equipment (UE), comprising:
at least one processor configured to:
determine a first starting symbol position for one or more downlink channels based on channel monitoring;
determine a second starting position for the one or more downlink channels based on received signaling; and
employ the first or second starting symbol position based on an event; and
a memory coupled with the at least one processor.

68. The apparatus of claim 67, wherein:
the event is a RACH UE response time window during a contention-based RACH procedure; and
employing the first or second starting symbol position based on an event includes employing the first starting symbol position.

69. A computer program product, comprising:
a computer-readable medium comprising code for:
determining a first starting symbol position for one or more downlink channels based on channel monitoring;
determining a second starting position for the one or more downlink channels based on received signaling; and
employing the first or second starting symbol position based on an event.

70. The computer program product of claim 69, wherein:
the event is a RACH UE response time window during a contention-based RACH procedure; and
employing the first or second starting symbol position based on an event includes employing the first starting symbol position.
